(19) United States
(12) Patent Application Publication
(10) Pub. No.: US 2024/0416662 A1
(43) Pub. Date: Dec. 19, 2024

(54) PRINTING APPARATUS, METHOD FOR CONTROLLING SAME, AND STORAGE MEDIUM

(71) Applicant: CANON KABUSHIKI KAISHA, Tokyo (JP)

(72) Inventors: AKIHIRO TOMIDA, Kanagawa (JP); TOSHIMITSU DANZUKA, Tokyo (JP); RIE TAKEKOSHI, Kanagawa (JP); KEITA ISHIMI, Kanagawa (JP); AKIKO AICHI, Tokyo (JP); HIROTO KANGO, Tokyo (JP)

(21) Appl. No.: 18/741,009

(22) Filed: Jun. 12, 2024

(30) Foreign Application Priority Data
Jun. 13, 2023 (JP) 2023-097241

(51) Int. Cl. B41J 2/18; B41J 2/165; B41J 2/21

(52) U.S. Cl. CPC B41J 2/18; B41J 2/16505; B41J 2/2103

(57) ABSTRACT

A printing apparatus includes an ink discharge head including a plurality of discharge ports that respectively discharge a plurality of types of ink, and a plurality of circulation paths for circulating ink between the plurality of discharge ports and a plurality of liquid chambers that respectively house the plurality of types of ink; a circulation mechanism that circulates ink in the plurality of circulation paths; and a control unit that performs control to determine, based on print data, which path among the plurality of circulation paths that circulation mechanism is to circulate ink in.

### BACKGROUND OF THE INVENTION

### Field of the Invention

The present invention relates to a printing apparatus that circulates ink in a circulation path including a print head.

### Description of the Related Art

In an inkjet printing apparatus using water-based ink, when water in the ink evaporates from the nozzle of a print head, the viscosity of the ink at or near the discharge port is increased, causing various kinds of problems when discharging ink from the nozzle.

A known method to combat this problem includes forming two flow paths in the nozzle and circulating ink between a liquid chamber in the head and the nozzle so that ink with viscosity increased by water evaporation at or near the nozzle is removed and substituted with non-evaporated ink. However, when looking at the overall circulation path, as the evaporation of water from the nozzle progresses, the water content in the circulation path gradually decreases, causing the problem of ink concentration.

Regarding this, Japanese Patent Laid-Open No. 2017-121784 describes a technique for circulating ink of only the color to be discharged in image formation. Specifically, control is performed so that at the time of monochrome printing, only black ink is circulated and color ink is not circulated, reducing concentration due to water evaporation in color ink.

However, in the case of control to not circulate ink not used in image formation, as water evaporation at or near the nozzle progresses, the viscosity of the ink increases, and the ink with increased viscosity may not come out of the nozzle when circulation is attempted again. In particular, with a nozzle row to be used in image formation and an unused nozzle row in the same chip, temperature retention control and temperature increases due to discharge cause an increase in the temperature of the ink. This promotes water evaporation, leading to an early-stage increase in viscosity. In such cases, as well as faulty ink discharge, the ink with increased viscosity in the nozzle becomes unable to be re-circulated even if attempted.

### SUMMARY OF THE INVENTION

The present invention has been made in consideration of the aforementioned problems and suppresses the effects of ink concentration on ink discharge.

According to a first aspect of the present invention, there is provided a printing apparatus, comprising: an ink discharge head including a plurality of discharge ports that respectively discharge a plurality of types of ink, and a plurality of circulation paths for circulating ink between the plurality of discharge ports and a plurality of liquid chambers that respectively house the plurality of types of ink; a circulation mechanism that circulates ink in the plurality of circulation paths; and at least one processor or circuit configured to function as: a control unit that performs control to determine, based on print data, which path among the plurality of circulation paths that circulation mechanism is to circulate ink in.

According to a second aspect of the present invention, there is provided a method for controlling a printing apparatus provided with an ink discharge head including a plurality of discharge ports that respectively discharge a plurality of types of ink, and a plurality of circulation paths for circulating ink between the plurality of discharge ports and a plurality of liquid chambers that respectively house the plurality of types of ink, the method comprising: performing circulation to circulate ink in the plurality of circulation paths; and performing control to determine, based on print data, which path among the plurality of circulation paths that circulation mechanism is to circulate ink in.

Further features of the present invention will become apparent from the following description of exemplary embodiments with reference to the attached drawings.

### BRIEF DESCRIPTION OF THE DRAWINGS

FIGS. 1A and 1B are diagrams for explaining a liquid discharge apparatus.

FIG. 2 is a perspective view of a recovery unit.

FIG. 3 is a perspective view of a liquid discharge head.

FIG. 4 is an exploded perspective view illustrating the liquid discharge head.

FIGS. 5A and 5B are a vertical cross-sectional view of the liquid discharge head and an enlarged cross-sectional view of a discharge module.

FIG. 6 is a schematic external appearance view of a circulation unit.

FIG. 7 is a vertical cross-sectional view illustrating a circulation path.

FIG. 8 is a block diagram schematically illustrating the circulation path.

FIGS. 9A to 9C are cross-sectional views illustrating examples of a pressure adjusting unit.

FIGS. 10A and 10B are perspective views of a circulation pump.

FIG. 11 is a cross-sectional view taken along IX-IX of the circulation pump illustrated in FIG. 8A.

FIGS. 12A to 12E are diagrams for explaining the flow of ink in the liquid discharge head.

FIG. 13 is a schematic view illustrating the circulation path in the discharge unit.

FIG. 14 is a diagram illustrating an opening plate.

FIG. 15 is a diagram illustrating a discharge element substrate.

FIGS. 16A to 16C are cross-sectional views illustrating the ink flow in the discharge unit.

FIGS. 17A and 17B are cross-sectional views illustrating the region at or near the discharge port.

FIGS. 18A and 18B are cross-sectional views illustrating a comparative example of the region at or near the discharge port.

FIG. 19 is a diagram illustrating a comparative example of the discharge element substrate.

FIGS. 20A and 20B are diagrams illustrating a flow path configuration of the liquid discharge head.

FIGS. 21A and 21B are schematic views of an ink concentrated state at or near the nozzle.

FIG. 22 is a graph of ink concentration in the circulation path over printing operation elapsed time.

FIG. 23 is a graph of concentrated ink ejection amount.

FIG. 24 is a correspondence table of printing conditions and ink to be used.

FIG. 25 is a flowchart of circulation determination during a printing operation.

FIG. 26 is a flowchart of recovery determination before the start of a printing operation.

### DESCRIPTION OF THE EMBODIMENTS

Preferred embodiments of the present disclosure will be described in detail below with reference to the attached drawings. Note that the embodiments described below do not limit the content of the present disclosure, and all of the combinations of advantages described in the embodiments are not necessary for the resolution means of the present disclosure. Note that components that are the same are given the same reference number. The present embodiment will be described using an example in which a thermal type discharge element that discharge a liquid by generating bubbles with an electrothermal conversion element is used as the discharge element that ejects a liquid, but no such limitation is intended. The present embodiment is applicable to a liquid discharge head that discharges liquid using a piezoelectric element (piezo) or that uses a different discharge method. Furthermore, the pumps, pressure adjusting units, and the like described below are not limited to the configurations described in the embodiment and illustrated in the drawings, and components with similar functions can be used.

### Liquid Discharge Apparatus

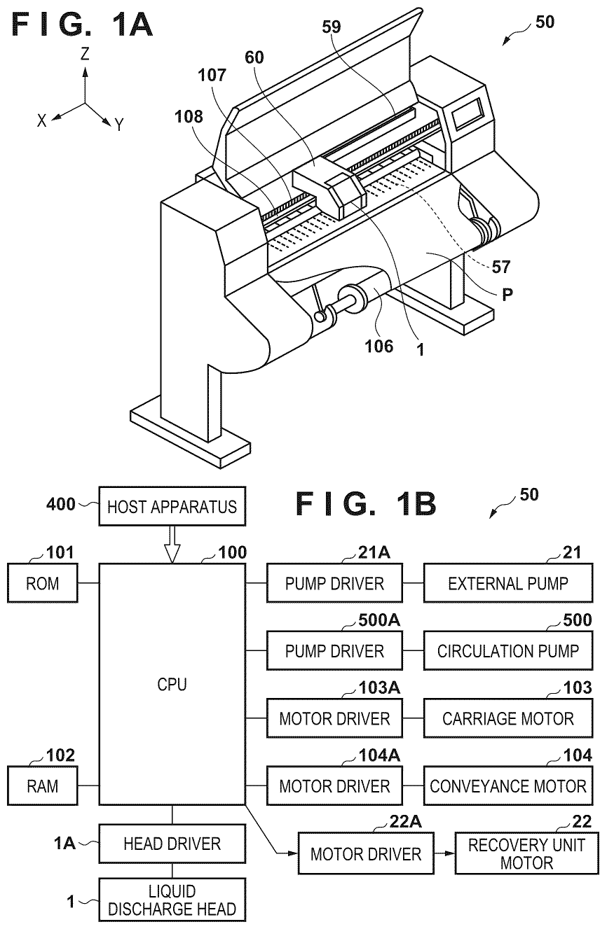

FIGS. 1A and 1B are diagrams for explaining a liquid discharge apparatus. Firstly, a schematic configuration of a liquid discharge apparatus 50 according to the present embodiment will be described with reference to FIGS. 1A and 1B. FIG. 1A is a schematic perspective view illustrating a liquid discharge apparatus using a liquid discharge head 1. The liquid discharge apparatus 50 according to the present embodiment is configured as a serial inkjet printing apparatus that can scan the liquid discharge head 1 and can also print on a printing medium P by discharging ink as the liquid.

An outline of the configuration of this inkjet printing apparatus and its operations when printing will now be given using FIGS. 1A and 1B. Firstly, the printing medium P is conveyed in the Y direction from a spool 106 that supports the printing medium P by a conveyance roller driven by a conveyance motor 104 via a gear. At a predetermined conveying position, a carriage 60 is made to scan back and forth (move back and forth) by a carriage motor 103 (see FIG. 1B) in the X direction along a guide shaft 108 that extends in the X direction.

The printing medium P is conveyed by a conveyance roller in the sub-scan direction (Y direction) that intersects (in the present example, is orthogonal to) the main scan direction. Note that in each diagram referenced below, the Z direction is the vertical direction that intersects (in the present example, is orthogonal to) the X-Y plane defined by the X direction and the Y direction. The liquid discharge head 1 can be detached from and attached to the carriage 60 by a user.

In the process of scanning by the carriage 60, at a timing based on a position signal obtained by an encoder 107, a discharge operation using the nozzle of the liquid discharge head 1 is performed and a certain band width corresponding to the nozzle array area is printed. Thereafter, the printing medium P is conveyed, and printing is performed for the next band width.

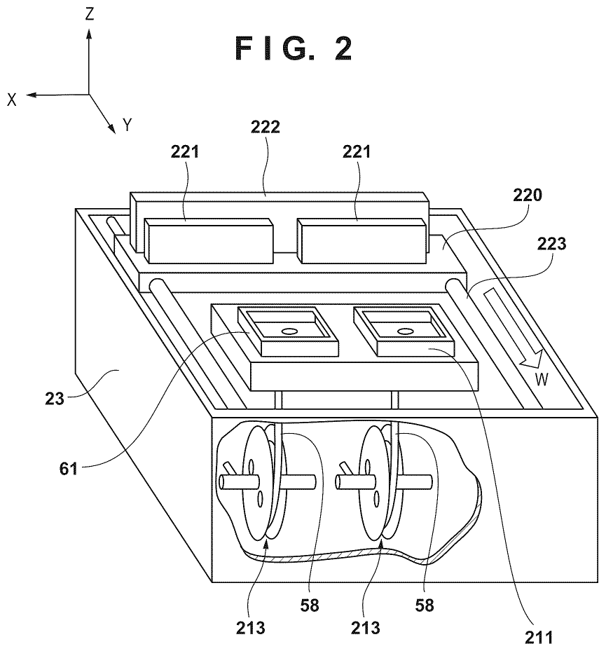

The fed printing medium P is conveyed between a feeding roller and a pinch roller and guided to a print position (scan region of the liquid discharge head 1) on a platen 57. Normally, in a resting state, the face surface of the liquid discharge head 1 is capped by a cap 61 provided in a recovery unit 23 (see FIG. 2). Thus, before printing, the cap is removed to put the liquid discharge head 1 or the carriage 60 in a scannable state. Thereafter, when an amount of data corresponding to one scan is accumulated at the buffer, the carriage 60 is made to scan by the carriage motor 103, and printing is performed as described above.

Note that a carriage belt (not illustrated) can be used to transfer the driving force from the carriage motor 103 to the carriage 60. However, instead of a carriage belt, a lead screw that extends in the X direction and is rotationally driven by the carriage motor 103 and an engagement portion provided on the carriage 60 that engages with the grooves in the lead screw can be used, or another driving method can be used.

Also, the ink supplied to the liquid discharge head 1 is supplied via the carriage 60 by an ink supply tube 59 from an ink tank 2 (see FIG. 8) installed inside the apparatus or an external unit. The ink may be supplied from the ink tank 2 to the liquid discharge head 1 using a pressure unit or may be supplied via suction by generating negative pressure inside the cap using a suction pump after capping the nozzle surface of the liquid discharge head 1 using the cap of the recovery unit 23.

Also, the liquid discharge head 1 may be installed with one carriage or a plurality of carriages for discharging ink of a plurality of colors or a single liquid discharge head 1 that can discharge a plurality of colors may be installed in a carriage.

Note that in the description of the present embodiment, the position in the X direction where the liquid discharge head 1 is capped during a non-printing operation is referred to as the standard side, and the direction of movement from the capping position relative to this position during a printing operation is referred to as the non-standard side.

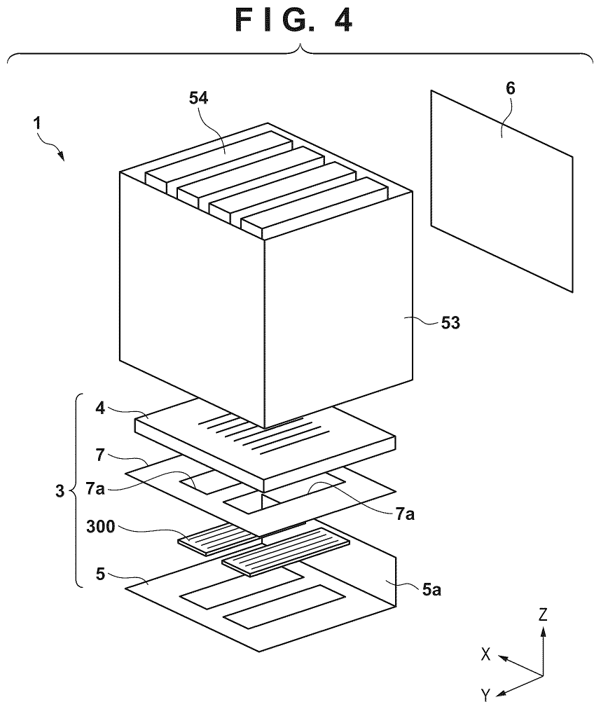

The liquid discharge head 1 includes a circulation unit 54 and a discharge unit 3 (see FIG. 4) described below. The discharge unit 3 includes a plurality of discharge ports and an energy generating element (hereinafter, referred to as a discharge element) that generates discharge energy for discharging liquid from each discharge port. A detailed configuration is described further below.

Also, the liquid discharge apparatus 50 includes the ink tank 2, which is the ink supply source, and an external pump 21. The ink stored in the ink tank 2 is supplied to the circulation unit 54 via the ink supply tube 59 by the driving force of an external pump 21.

The liquid discharge head 1 includes the circulation unit 54 in accordance with the type of liquid to be discharged. A plurality of the circulation units 54 may be provided for the same type of liquid. In other words, the liquid discharge head 1 can be configured to include one or more circulation units. Also, the liquid discharge head 1 of this example illustrated in FIG. 1A is a serial liquid discharge head, meaning that it discharges ink while moving in the main scan direction. However, no such limitation is intended. The liquid discharge head may be a so-called full line liquid discharge head with a discharge port formed across the entire width direction of the printing medium P allowing it to discharge across the entire width direction of the printing medium P without moving in the main scan direction.

FIG. 1B is a block diagram illustrating the control system of the liquid discharge apparatus 50. A CPU 100 functions as a controlling unit that controls the operations of each unit of the liquid discharge apparatus 50 on the basis of a program such as a processing process stored in a ROM 101. Also, the ROM 101 stores multivalued grayscale data of an intermediate product and a multi-pass mask. A RAM 102 is used as a working area or the like when the CPU 100 executes processing. The CPU 100 receives image data from a host apparatus 400 external to the liquid discharge apparatus 50, controls a head driver 1A, and controls the driving of the discharge element provided in the liquid discharge head 1. Also, the CPU 100 controls various actuator drivers provided in the liquid discharge apparatus 50. For example, the CPU 100 controls a motor driver 103A of the carriage motor 103 for moving the carriage 60, a motor driver 104A of the conveyance motor 104 for conveying the printing medium P, and the like. Also, the CPU 100 controls a pump driver 500A that drives a circulation pump 500 described below, a pump driver 21A of the external pump 21, a motor driver 22A of a recovery unit motor 22, and the like. The recovery unit motor 22 is a motor installed in the recovery unit 23 that operates a wiper guide 223 and a suction pump 213 while switching the unit to drive with a cam shaft. Note that in FIG. 1B, a configuration for executing processing after receiving image data from the host apparatus 400 is illustrated. However, processing at the liquid discharge apparatus 50 may be executed without depending on data from the host apparatus 400.

### Recovery Unit

FIG. 2 is a schematic view of the recovery unit 23 according to the present embodiment. The cap 61 is supported in a manner allowing it to be moved up and down via a raising and lowering mechanism (not illustrated) and moves between a raised position and a lowered position. The cap 61 covers (caps) the nozzle surface of the liquid discharge head 1 by coming into contact with the liquid discharge head 1 at the raised position. By covering the nozzle surface of the liquid discharge head 1, the cap 61 helps suppress the nozzle of the liquid discharge head 1 from drying out during non-printing operations and suppresses the evaporation of ink. It may also be used in a case where ink is suctioned from the liquid discharge head 1 by the suction pump 213 described below being driven. Also, during printing operations, the cap 61 is located at the lowered position to avoid interference with the liquid discharge head 1 that moves together with the carriage 60. When the cap 61 is located at the lowered position, the liquid discharge head 1 can perform preliminary discharge to the cap 61 when moved to a position where it faces the cap 61.

Wipers (wiper blades) 221 and 222 are formed of an elastic member such as rubber. In the present embodiment, the wipers 221 and 222 include two wipers 221 that wipe the nozzle surfaces of two chips and one wiper 222 that wipes the entire nozzle surface including the nozzle array. The wipers 221 and 222 are fixed to a wiper holder 220. The wiper holder 220 can move along the wiper guide 223 in the front-and-back direction (nozzle arrangement direction in the liquid discharge head 1) as illustrated with arrow W. When the liquid discharge head 1 is located at the standby position, the wiper holder 220 can be moved in the direction of arrow W (one direction) to bring the wipers 221 and 222 into contact with the nozzle surfaces to perform the wiping operation of wiping the nozzle surfaces. When the wiping operation ends, the carriage 60 is moved away from the region where the wiping operation is performed, before the wiper holder 220 is moved and the wipers 221 and 222 are returned to the original position (pre-wiping operation position).

Note that in the present embodiment, the wipers are formed of an elastic member such as rubber, but they may be a member formed of a porous material that absorbs ink. Also, the wipers may have a vacuum wiper configuration that can suction the nozzle surface. Also, in the present embodiment, wiping is performed only in the case where the wipers are moved in one direction, but another configuration may be used in which wiping is performed by moving the wipers back and forth in both directions. Also, in the present embodiment, the wiping direction is the nozzle arrangement direction in the liquid discharge head 1, but another configuration may be used in which the wipers are moved in a direction that intersects (is orthogonal to) this direction (a direction that intersects the arrangement direction of the nozzle array). Also, with this configuration, a configuration may be used in which the wipers are fixed and the carriage 60 is moved in the scanning direction to wipe the nozzle surface. Also, with a configuration in which there are a plurality of wiping members or wiping is performed in different wiping directions, the position of each recovery unit may be located separately. In this case, the recovery units may be disposed divided between near the standby position of the carriage unit and on the opposite side of the printing medium.

The suction pump 213 is driven in a state where the cap 61 is covering the nozzle surface of the liquid discharge head 1 and the inside is made a substantially sealed space. The suction operation by the suction pump 213 suctions ink from the liquid discharge head 1 by generating a negative pressure inside. The suction operation is performed when the liquid discharge head 1 is filled with ink from the ink tank 2 (initial filling) or when suction removal of dust and dirt, particles, air bubbles, and the like in the nozzle is performed (suction recovery). The cap 61 is connected to a waste ink absorber (not illustrated) via a flexible tube 58.

In the present embodiment, a tube pump is used as the suction pump 213. The tube pump includes a holding portion formed with a curved surface portion that conforms to and holds (at least a part of) the tube 58, a roller that can press the held tube 58, and a roller support portion that supports the roller in a manner allowing for rotation. The tube pump rotates the roller while squeezing the tube 58 by rotating the roller support portion in a predetermined direction. In this manner, negative pressure is generated inside the cap 61, and ink is suctioned from the liquid discharge head 1. The suctioned ink is ejected to the waste ink absorber via the tube 58. Also, the suction operation is performed in the case of performing preliminary discharge to the cap 61 by the liquid discharge head 1 and in the case of ejecting the ink received at the cap 61 via the preliminary discharge. In other words, by driving the suction pump 213 when the link held at the cap 61 after preliminary discharge reaches a predetermined amount, the ink held inside the cap 61 can be ejected to the waste ink absorber via the tube 58.

### Basic Configuration of Liquid Discharge Head

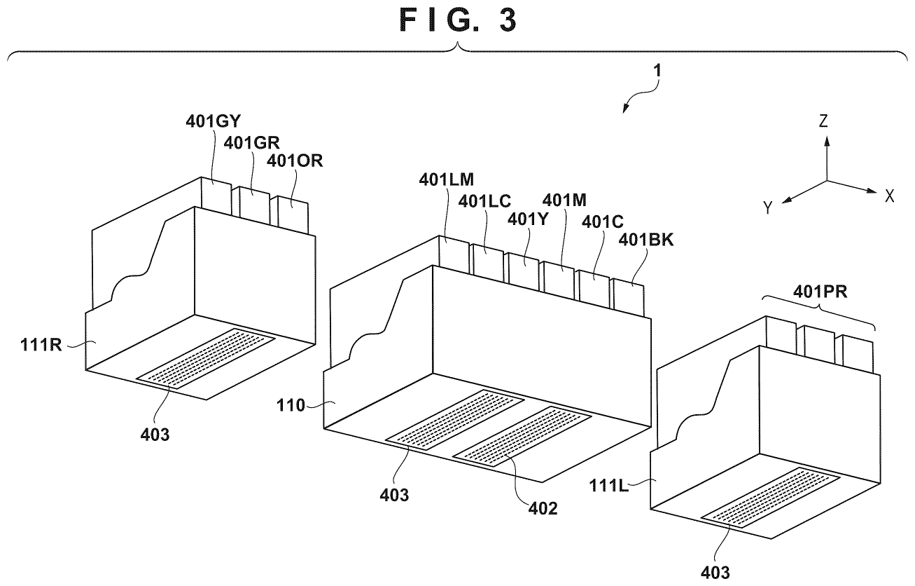

FIG. 3 is a diagram illustrating the configuration of the liquid discharge head 1 according to the present embodiment. In the present embodiment, the liquid discharge head 1 is configured of a total of three liquid discharge heads, a single liquid discharge head 110 that can print six colors of ink (a plurality of types of ink) and two liquid discharge heads 111 that can print three colors of ink (a plurality of types of ink). The liquid discharge heads according to the present embodiment are arranged in order from the liquid discharge head 111, the liquid discharge head 110, the liquid discharge head 111 from the scanning direction standard side. Note that to distinguish between them, the liquid discharge head on the scanning direction standard side is referred to as 111R and the liquid discharge head on the non-standard side is referred to as 111L.

Also, the ink is arranged with all of the three primary colors disposed in the liquid discharge head 111L, and three buffer tanks 401PR are provided. In the central liquid discharge head 110, color ink is disposed from the standard side in order from light magenta, light cyan, yellow, magenta, cyan, and black, and independent buffer tanks 401LM, 401LC, 401Y, 401M, 401C, and 401BK are provided for the six colors of ink. In the liquid discharge head 111R, buffer tanks 401GY, 401GR, and 401OR are provided for the three colors ink, gray, green, and orange in this order from the standard side. Note that in FIG. 3, the buffer tanks are illustrated to be visible to facilitate the description, but the buffer tanks are stored inside the liquid discharge heads. Also, the arrangement of the liquid discharge heads and the ink are not limited, the number of ink colors disposed in one liquid discharge head may not be three, and the order of the colors may not be that described in the example given in the present embodiment.

A chip 403 formed with a nozzle array corresponding to the respective ink is disposed on the lower surfaces of the liquid discharge heads 110 and 111. In the chip 403, 1024 nozzles 402 are arranged in two rows at an interval of 1200 dpi per color, and one chip can discharge three colors. The liquid discharge head 110 is provided with the chip 403 formed with discharge ports for discharging light magenta, light cyan, and yellow and the chip 403 formed with discharge ports for discharging magenta, cyan, and black, allowing it to print in six colors. The liquid discharge heads 111 are each provided with the one chip 403 and can print in three colors. Note that a one-color nozzle array does not need to be arranged on the same straight line, and each nozzle may be arranged differently. For example, a total of four rows of nozzle arrays of 512 nozzles at an interval of 600 dpi may be used. The arrangement of color is not limited to this example, and, for example, the liquid discharge head 110 may include the chip 403 formed with discharge ports for discharging black, light cyan, and cyan and the chip 403 formed with discharge ports for discharging yellow, light magenta, and magenta.

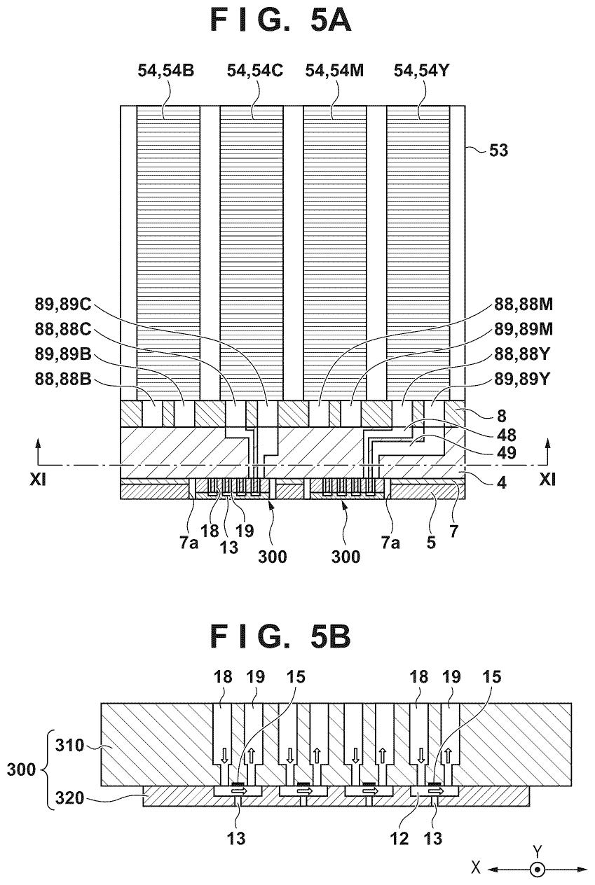

FIG. 4 is an exploded perspective view illustrating the liquid discharge head 1 according to the present embodiment. FIGS. 5A and 5B are vertical cross-sectional views of the liquid discharge head 1. FIG. 5A is an overall vertical cross-sectional view of the liquid discharge head 1, and FIG. 5B is an enlarged view of the discharge module illustrated in FIG. 5A. Hereinafter, the liquid discharge head 1 according to the present embodiment will be described while focusing on FIGS. 4 and 5A and 5B but also referencing FIGS. 1A and 1B as appropriate.

As illustrated in FIG. 4, the liquid discharge head 1 includes the circulation unit 54 and the discharge unit 3 for discharging ink supplied from the circulation unit 54 to the printing medium P. The liquid discharge head 1 according to the present embodiment is fixedly supported to the carriage 60 by a positioning unit and an electrical contact (not illustrated) provided in the carriage 60 of the liquid discharge apparatus 50. Also, the liquid discharge head 1 discharges ink while moving the main scan direction (X direction) illustrated in FIGS. 1A and 1B together with the carriage 60 to print on the printing medium P.

The external pump 21 connected to the ink tank 2 corresponding to the ink supply source is provided with the ink supply tube 59 (see FIGS. 1A and 1B). A liquid connector (not illustrated) is provided at the distal end of the ink supply tube 59. When the liquid discharge head 1 is installed in the liquid discharge apparatus 50, the liquid connector provided at the distal end of the ink supply tube 59 forms an airtight connection with a liquid connector insertion port (not illustrated) provided in a head casing 53 in the liquid discharge head 1. In this manner, an ink supply path from the ink tank 2, through the external pump 21, to the liquid discharge head 1 is formed. In the present embodiment, since four types of ink are used, four sets of the ink tank 2, the external pump 21, the ink supply tube 59, and the circulation unit 54 are provided for the four types of ink, and four ink supply paths associated with the four types of ink are independently formed. Accordingly, the liquid discharge apparatus 50 according to the present embodiment includes an ink supply system for supplying ink from the ink tank 2 provided external to the liquid discharge head 1. Note that the liquid discharge apparatus 50 according to the present embodiment does not include an ink collection system for collecting the ink in the liquid discharge head 1 in the ink tank 2.

In FIGS. 5A and 5B, 54B denotes a circulation unit for black ink, 54C denotes a circulation unit for cyan ink, 54M denotes a circulation unit for magenta ink, and 54Y denotes a circulation unit for yellow ink. Each circulation unit has substantially the same configuration, and when no distinction is made between the circulation units in the present embodiment, circulation unit 54 is used.

In FIGS. 4 and 5A, the discharge unit 3 includes two discharge modules 300, a first support member 4, a second support member 7, an electrical wiring member (electrical wiring tape) 5, and an electrical contact substrate 6. As illustrated in FIG. 5B, the discharge modules 300 includes a silicon substrate 310 with a thickness ranging from 0.5 to 1 mm and a plurality of discharge elements 15 provided on one surface of the silicon substrate 310. The discharge elements 15 according to the present embodiment are formed of an electrothermal conversion element (heater) that generates thermal energy as discharge energy for discharging liquid. Each discharge element 15 is supplied with power via the electrical wiring formed via a depositing technique on the silicon substrate 310.

Also, a discharge port forming member 320 is formed on the front surface (lower surface in FIG. 5B) of a silicon substrate 310. A plurality of pressure chambers 12 corresponding to a plurality of discharge elements 15 and a plurality of discharge ports 13 for discharging ink are formed on the discharge port forming member 320 by a photolithography technique. Also, an individual supply path 18 and individual collection path 19 that communicate with their respective pressure chamber 12 are formed in the silicon substrate 310. In the present embodiment, one discharge module 300 is configured to discharge two types of ink. In other words, of the two discharge modules illustrated in FIG. 5A, the discharge module 300 located on the left side of the diagram discharges black ink and cyan ink, and the discharge module 300 located on the right side of the diagram discharges magenta ink and yellow ink. Also, in the example illustrated in FIGS. 5A and 5B, two discharge port rows extending in the Y direction are formed for ink of one color. For each of the plurality of discharge ports 13 forming each discharge port row, the respective pressure chamber 12, individual supply path 18, and individual collection path 19 are formed.

An ink supply port and an ink collection port are formed in the back surface (upper surface in FIG. 5B) of the silicon substrate 310. The ink supply port supplies ink from an ink supply path 48 to the plurality of individual supply paths 18, and the ink collection port collects ink in an ink collection path 49 from the plurality of individual collection paths 19.

Note that the ink supply port and the ink collection port described herein represent openings for supplying and collecting ink when ink is circulated in the forward direction described below. In other words, when the ink is circulated in the forward direction, the ink is both supplied to each individual supply path 18 from the ink supply port and collected at the ink collection port from each individual collection path 19. However, when the ink is circulated by sending the ink in the reverse direction to the forward direction, the ink is both supplied to the individual collection paths 19 from the ink collection port described above and collected at the ink supply port from the individual supply paths 18.

As illustrated in FIG. 5A, the discharge modules 300 are, at their back surface (upper surface in FIG. 5A), bonded and fixed to one surface (lower surface in FIG. 5A) of the first support member 4. The ink supply path 48 and the ink collection path 49 are formed in the first support member 4 extending through from this one side to the other side. One opening of the ink supply path 48 communicates with the ink supply port described above in the silicon substrate 310, and one opening of the ink collection path 49 communicates with the ink collection port described above in the silicon substrate 310. Note that the ink supply path 48 and the ink collection path 49 are independently provided per type of ink.

Also, the second support member 7 including openings 7a (see FIG. 4) where the discharge modules 300 are inserted is bonded and fixed to the other surface (upper surface in FIG. 5A) of the first support member 4. An electrical wiring member 5 electrically connected to the discharge modules 300 is supported by the second support member 7. The electrical wiring member 5 is a member for applying an electrical signal for discharging ink to the discharge modules 300. The electrical connection portion between the discharge modules 300 and the electrical wiring member 5 is sealed by a sealing material to protected them from corrosion due to ink and external shock.

Also, the electrical contact substrate 6 is thermocompression-bonded to an end portion 5a (see FIG. 4) of the electrical wiring member 5 using an anisotropic conductive film (not illustrated), and the electrical wiring member 5 and the electrical contact substrate 6 are electrically connected to one another. The electrical contact substrate 6 includes an external signal input terminal (not illustrated) for receiving electrical signals from the liquid discharge apparatus 50.

Also, a joint member 8 (FIG. 5A) is provided between the first support member 4 and the circulation unit 54. In the joint member 8, a supply port 88 and a collection port 89 are formed for each type of ink. The supply port 88 and the collection port 89 function to connect a flow path formed in the circulation unit 54 to the ink supply path 48 and the ink collection path 49 of the first support member 4. Note that in FIG. 5A, a supply port 88B and a collection port 89B are associated with black ink, and supply port 88C and collection port 89C are associated with cyan ink. Also, supply port 88M and collection port 89M are associated with magenta ink, and supply port 88Y and collection port 89Y are associated with yellow ink.

Note that the opening at one end portion of the ink supply path 48 and the ink collection path 49 of the first support member 4 has a small opening area to conform with the ink supply port and the ink collection port in the silicon substrate 310. However, the opening area of the opening at the other end portion of the ink supply path 48 and the ink collection path 49 of the first support member 4 has a shape that is enlarged to have the same opening area as the large opening area of the joint member 8 formed to conform to the flow path of the circulation unit 54. By using this configuration, an increase in flow path resistance relating to the ink collected from each collection path can be suppressed.

In the liquid discharge head 1 with this configuration, the ink supplied to the circulation unit 54 travels through the supply port 88 of the joint member 8 and the ink supply path 48 of the first support member 4 and enters the individual supply path 18 from the ink supply port of the discharge module 300. Next, the ink enters the pressure chamber 12 from the individual supply path 18, and a portion of the ink in the pressure chamber 12 is discharged from the discharge port 13 by driving the discharge element 15. The remaining non-discharged ink travels from the pressure chamber 12 through the individual collection path 19 and enters the ink collection path 49 of the first support member 4 from the ink collection port. Then, the ink in ink the collection path 49 travels through the collection port 89 of the joint member 8, enters the circulation unit 54, and is collected.

### Circulation Unit Components

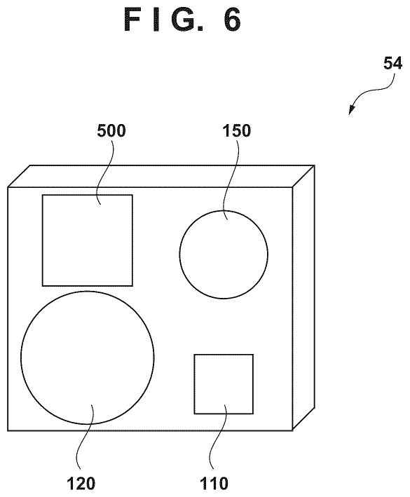

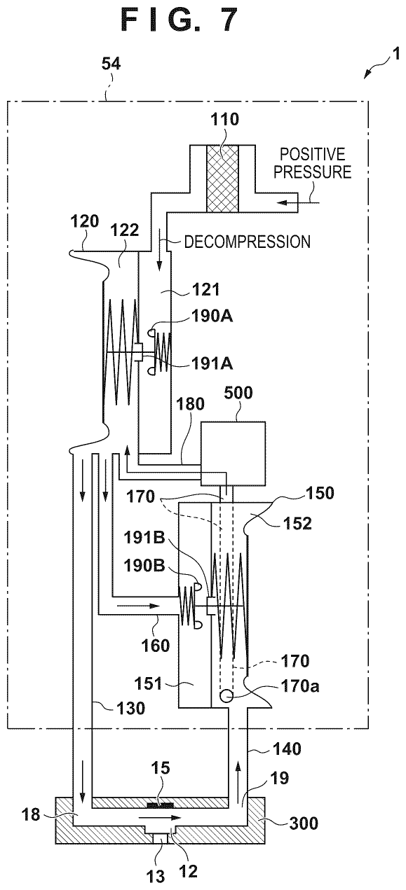

FIG. 6 is a schematic external appearance view of one circulation unit 54 associated with one type of ink used in a printing apparatus according to the present embodiment. In the circulation unit 54, a filter 110, a first pressure adjusting unit 120, a second pressure adjusting unit 150, and the circulation pump 500 are arranged. These components form, in the liquid discharge head 1, a circulation path for supplying and collecting ink for the discharge modules 300 that is connected via each flow path, as illustrated in FIGS. 7 and 8.

### Circulation Path Inside Liquid Discharge Head

FIG. 7 is a vertical cross-sectional view schematically illustrating a circulation path of one type of ink (ink of one color) formed in the liquid discharge head 1. FIG. 8 is a block diagram schematically illustrating the circulation path illustrated in FIG. 7. As illustrated in FIGS. 7 and 8, the first pressure adjusting unit 120 includes a first valve chamber 121 and a first pressure control chamber 122. The second pressure adjusting unit 150 includes a second valve chamber 151 and a second pressure control chamber 152. The first pressure adjusting unit 120 is configured to have a higher control pressure relative to the second pressure adjusting unit 150. In the present embodiment, by using the two pressure adjusting units 120 and 150, circulation within a certain pressure range can be implemented in the circulation path. Also, with this configuration, the ink travels at or near the pressure chamber 12 (discharge element 15) at a flow rate corresponding to the pressure difference between the first pressure adjusting unit 120 and the second pressure adjusting unit 150. The circulation path in the liquid discharge head 1 and the flow of ink in the circulation path will be described below with reference to FIGS. 7 and 8. Note that the arrows in each diagram indicate the direction of ink flow.

Firstly, the connection state of each component in the liquid discharge head 1 will be described.

The external pump 21 that sends the ink housed in the ink tank 2 (FIG. 8) provided external to the liquid discharge head 1 to the liquid discharge head 1 is connected to the circulation unit 54 via the ink supply tube 59 (FIGS. 1A and 1B). The filter 110 is provided in the ink flow path located on the upstream side of the circulation unit 54. The ink supply path located on the downstream side of the filter 110 is connected to the first valve chamber 121 of the first pressure adjusting unit 120. The first valve chamber 121 connects to the first pressure control chamber 122 via a communicating port 191A that is opened and closed by a valve 190A illustrated in FIG. 7.

The first pressure control chamber 122 is connected to a supply path 130, a bypass flow path 160, and a pump outlet path 180 of the circulation pump 500. The supply path 130 is connected to the individual supply path 18 via the ink supply port described above provided in the discharge module 300. Also, the bypass flow path 160 is connected to the second valve chamber 151 provided in the second pressure adjusting unit 150. The second valve chamber 151 communicates with the second pressure control chamber 152 via a communicating port 191B that is opened and closed by a valve 190B illustrated in FIG. 7.

The second pressure control chamber 152 is connected to a collection path 140. The collection path 140 is connected to the individual collection path 19 via the ink collection port described above provided in the discharge module 300. Also, the second pressure control chamber 152 is connected to the circulation pump 500 via a pump inlet flow path 170. Note that in FIG. 7, 170a denotes the flow inlet of the pump inlet flow path 170.

Next, the ink flow in the liquid discharge head 1 with the configuration described above will be described. As illustrated in FIG. 8, the ink housed in the ink tank 2 is pressurized by the external pump 21 provided in the liquid discharge apparatus 50 and supplied to the circulation unit 54 of the liquid discharge head 1 as an ink flow with positive pressure.

The ink supplied to the circulation unit 54 enters the first valve chamber 121 provided in the first pressure adjusting unit 120 after having foreign substances such as dust and dirt removed by being passed through the filter 110. At this time, a pressure loss occurs and the ink switches from positive pressure to negative pressure.

Next, the ink flow in the circulation path will be described. The circulation pump 500 operates to pump the ink suctioned from the pump inlet flow path 170 on the upstream side to the pump outlet path 180 on the downstream side. Accordingly, by driving the pump, the ink supplied to the first pressure control chamber 122 enters the supply path 130 and the bypass flow path 160 together with the ink fed from the pump outlet path 180. Though described below in detail, in the present embodiment, a piezoelectric diaphragm pump that uses a piezoelectric element attached to a diaphragm as a drive source is used as the circulation pump. The piezoelectric diaphragm pump is a pump that changes the volume in the pump chamber by applying a drive voltage to the piezoelectric element and feeding by alternately operating two check valves according to changes in pressure.

The ink in the supply path 130 enters into the pressure chamber 12 via the individual supply path 18 from the ink supply port of the discharge module 300, and a portion of the ink is supplied to the discharge port 13 and then discharged from the discharge port 13 by driving (heat generation) the discharge element 15. Also, the remaining ink not used in the discharge travels to the pressure chamber 12 and passes through the individual collection path 19 before entering the collection path 140 connected to the discharge module 300. The ink in the collection path 140 enters the second pressure control chamber 152 of the second pressure adjusting unit 150.

The ink in the bypass flow path 160 enters the second valve chamber 151 before passing through the communicating port 191B and entering the second pressure control chamber 152. The ink that entered the second pressure control chamber 152 through the bypass flow path 160 and the ink collected from the collection path 140 are suctioned into the circulation pump 500 via the pump inlet flow path 170 by driving the circulation pump 500. Then, the ink suctioned into the circulation pump 500 is sent to the pump outlet path 180 and again enters the first pressure control chamber 122. Thereafter, the ink that entered the second pressure control chamber 152 from the first pressure control chamber 122 and through the discharge modules 300 via the supply path 130 and the ink that entered the second pressure control chamber 152 via the bypass flow path 160 enter the circulation pump 500. Then, they are sent from the circulation pump 500 to the first pressure control chamber 122. This is how the ink circulation in the circulation path is performed.

As described above, the liquid can be circulated through the circulation path including the discharge module 300 by the circulation pump 500 provided in the liquid discharge head 1. Thus, an increase in the viscosity of ink in the discharge module 300 and deposits of sedimentation components of the ink color material can be suppressed, allowing for the fluidity of ink in the discharge module 300 and the discharge characteristics at the discharge port to be maintained in a good state. Also, since circulation outside of the liquid discharge head 1 is not necessary, a small pump can be used as the circulation pump 500, allowing the apparatus to be made smaller.

### Pressure Adjusting Unit

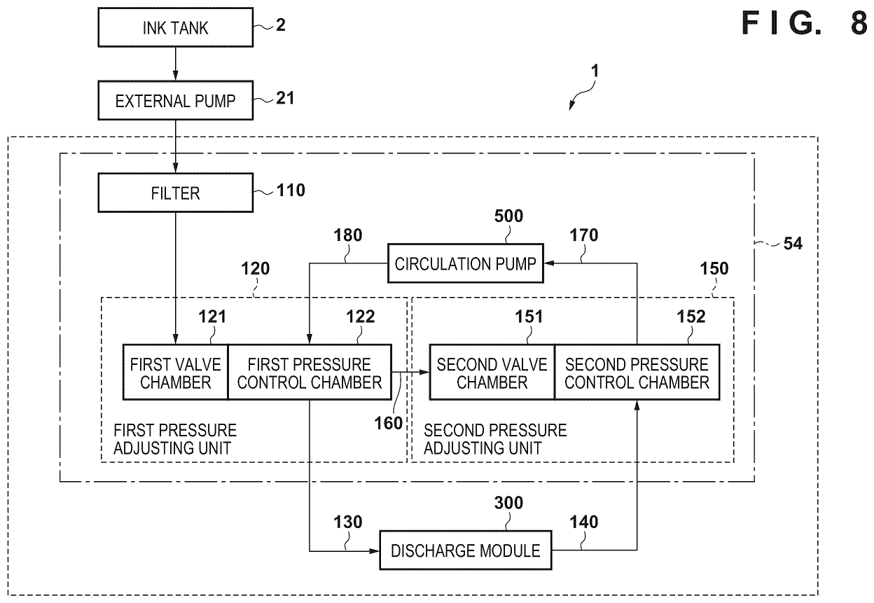

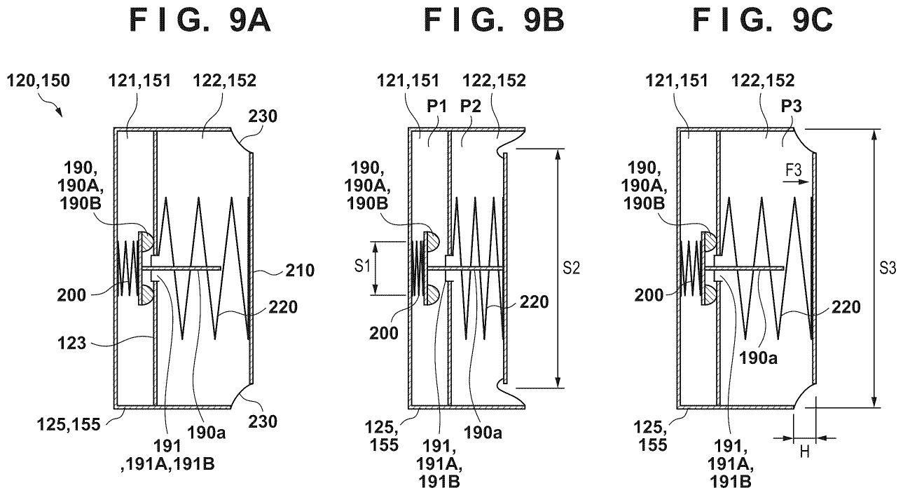

FIGS. 9A to 9C are diagrams illustrating examples of the pressure adjusting unit. The configuration and effects of the pressure adjusting units (first pressure adjusting unit 120 and second pressure adjusting unit 150) built into the liquid discharge head 1 described above will now be described in detail with reference to FIGS. 9A to 9C. Note that the first pressure adjusting unit 120 and the second pressure adjusting unit 150 have the same configuration. Thus, hereinafter, the first pressure adjusting unit 120 will be used in the description, and for the second pressure adjusting unit 150, only the reference signs of portions corresponding to those of the first pressure adjusting unit 120 are presented in FIGS. 9A to 9C. In the case of the second pressure adjusting unit 150, in the following description, the first valve chamber 121 is substituted with the second valve chamber 151, and the first pressure control chamber 122 is substituted with the second pressure control chamber 152.

The first pressure adjusting unit 120 includes the first valve chamber 121 and the first pressure control chamber 122 formed in a cylindrical casing 125. The first valve chamber 121 and the first pressure control chamber 122 are divided by a partition 123 provided in the cylindrical casing 125. However, the first valve chamber 121 communicates with the first pressure control chamber 122 via a communicating port 191 formed in the partition 123. A valve 190 for switching between connecting and cutting off the first valve chamber 121 and the first pressure control chamber 122 at the communicating port 191 is provided in the first valve chamber 121. The valve 190 has a configuration in which it is held at a position facing the communicating port 191 by a valve spring 200 and can come into tight contact with the partition 123 via the biasing force of the valve spring 200. By the valve 190 coming into tight contact with the partition 123, the flow of ink through the communicating port 191 is blocked. Note that since the tightness of the contact with the partition 123 is high, the contact portion of the valve 190 with the partition 123 is preferably formed of an elastic member. Also, a valve shaft 190a is disposed at a central portion of the valve 190 projecting through the communicating port 191. When the valve shaft 190a presses against the biasing force of the valve spring 200, the valve 190 separates from the partition 123, allowing for the flow of ink through the communicating port 191. Hereinafter, the state in which the flow of ink through the communicating port 191 is blocked by the valve 190 is referred to as the “closed state”, and the state in which the flow of ink through the communicating port 191 is allowed is referred to as the “open state”.

The opening portion of the cylindrical casing 125 is sealed by a flexible member 230 and a pressure plate 210. The flexible member 230, the pressure plate 210, the peripheral wall of the casing 125, and the partition 123 formed the first pressure control chamber 122. The pressure plate 210 is configured to move position in conjunction with the movement of the flexible member 230. The material of the pressure plate 210 and the flexible member 230 are not particularly limited. For example, the pressure plate 210 may be formed of a molded resin component, and the flexible member 230 may be formed of a resin film. In this case, the pressure plate 210 can be fixed to the flexible member 230 via thermal welding.

A pressure adjusting spring 220 is provided between the pressure plate 210 and the partition 123. Via the biasing force of the pressure adjusting spring 220, the pressure plate 210 and the flexible member 230 are biased in the direction for increasing the internal volume of the first pressure control chamber 122. Also, when the pressure in the first pressure control chamber 122 decreases, the pressure plate 210 and the flexible member 230 act against the pressure of the pressure adjusting spring 220 and move in the direction for decreasing the internal volume of the first pressure control chamber 122. Then, when the internal volume of the first pressure control chamber 122 decreases to a certain amount, the pressure plate 210 comes into contact with the valve shaft 190a of the valve 190. Thereafter, when the internal volume of the first pressure control chamber 122 further decreases, the valve 190 moves together with the valve shaft 190a acting against the biasing force of the valve spring 200 and separate from the partition 123. This puts the communicating port 191 in the open state.

In the present embodiment, the connection setting in the circulation path is made such that the pressure of the first valve chamber 121 when the communicating port 191 is in the open state is higher than the pressure of the first pressure control chamber 122. Accordingly, when the communicating port 191 is in the open state, the ink flows from the first valve chamber 121 into the first pressure control chamber 122. The ink flowing in causes the flexible member 230 and the pressure plate 210 to move in the direction for increasing the internal volume of the first pressure control chamber 122. As a result, the pressure plate 210 separates from the valve shaft 190a of the valve 190, the communicating port 191 comes into tight contact with the partition 123 via the biasing force of the valve spring 200, and the communicating port 191 is put in the closed state.

In this manner, in the first pressure adjusting unit 120 according to the present embodiment, when the pressure in the first pressure control chamber 122 decreases to a certain pressure or less (for example, when the negative pressure increases), ink flows through the communicating port 191 from the first valve chamber 121. According to this configuration, the pressure of the first pressure control chamber 122 cannot decrease more than this. Thus, the first pressure control chamber 122 is controlled to maintain the pressure within a certain range.

Next, the pressure of the first pressure control chamber 122 will be described in more detail.

As described above, consider an example in which the flexible member 230 and the pressure plate 210 are moved according to the pressure of the first pressure control chamber 122 and the pressure plate 210 comes into contact with the valve shaft 190a to put the communicating port 191 in the open state (state of FIG. 9B). At this time, the relationship of the forces acting on the pressure plate 210 is represented by the following Formula 1.

P2×S2+F2+(P1−P2)×S1+F1=0 Formula 1

Also, if Formula 1 is solved for P2, it becomes:

P2=−(F1+F2+P1×S1)/(S2−S1) Formula 2
P1: pressure (gauge pressure) of the first valve chamber 121
P2: pressure (gauge pressure) of the first pressure control chamber 122
F1: spring force of the valve spring 200
F2: spring force of the pressure adjusting spring 220
S1: pressure reception area of the valve 190
S2: pressure reception area of the pressure plate 210

For a spring force F1 of the valve spring 200 and a spring force F2 of the pressure adjusting spring 220, the direction in which the valve 190 and the pressure plate 210 are pushed is the positive direction (right direction in FIGS. 9A and 9C). Also, the relationship between a pressure P1 of the first valve chamber 121 and a pressure P2 of the first pressure control chamber 122 is configured such that P1 satisfies the relationship P1≥P2.

The pressure P2 of the first pressure control chamber 122 when the communicating port 191 is in the open state is determined by Formula 2, and when the communicating port 191 is put in the open state and the relationship P1>P2 is satisfied, ink flows from the first valve chamber 121 to the first pressure control chamber 122. As a result, the pressure P2 of the first pressure control chamber 122 does not decrease any more, and P2 is maintained at a pressure within a certain range.

On the other hand, as illustrated in FIG. 9C, the relationship of the force acting on the pressure plate 210 when the pressure plate 210 is in a non-contact state with the valve shaft 190a and the communicating port 191 is in the closed state corresponds to Formula 3.

P3×S3+F3=0 Formula 3

Here, if Formula 3 is rearranged to solve for P3, it becomes:

P3=−F3/S3 Formula 4
F3: spring force of the pressure adjusting spring 220 when the pressure plate 210 and the valve shaft 190a are in a non-contact state.
P3: pressure (gauge pressure) of the first pressure control chamber 122 when the pressure plate 210 and the valve shaft 190a are in a non-contact state.
S3: pressure reception area of the pressure plate 210 when the pressure plate 210 and the valve 190 are in a non-contact state.

Here, FIG. 9C illustrates a state in which the pressure plate 210 and the flexible member 230 are moved in the right direction in the diagram as far as they can move. The pressure P3 of the first pressure control chamber 122, the spring force F3 of the pressure adjusting spring 220, and the pressure reception area S3 of the pressure plate 210 change depending on how much the pressure plate 210 and the flexible member 230 move toward the state illustrated in FIG. 9C. Specifically, when the pressure plate 210 and the flexible member 230 move to the left direction in FIGS. 9A to 9C from the position in FIG. 9C, the pressure reception area S3 of the pressure plate 210 decreases and the spring force F3 of the pressure adjusting spring 220 increases. As a result, according to the relationship of Formula 4, the pressure P3 of the first pressure control chamber 122 decreases. Thus, according to Formula 2 and Formula 4, the pressure of the first pressure control chamber 122 gradually increases (in other words, the negative pressure becomes weaker and becomes a value closer to the positive pressure side) as the state moves from the state of FIG. 9B to the state of FIG. 9C. In other words, from the state in which the communicating port 191 is in the open state, while the pressure plate 210 and the flexible member 230 gradually move to the right direction and ultimately the internal volume of the first pressure control chamber 122 reaches the movable limit, the pressure of the first pressure control chamber 122 gradually increases. In other words, the negative pressure weakens.

### Circulation Pump

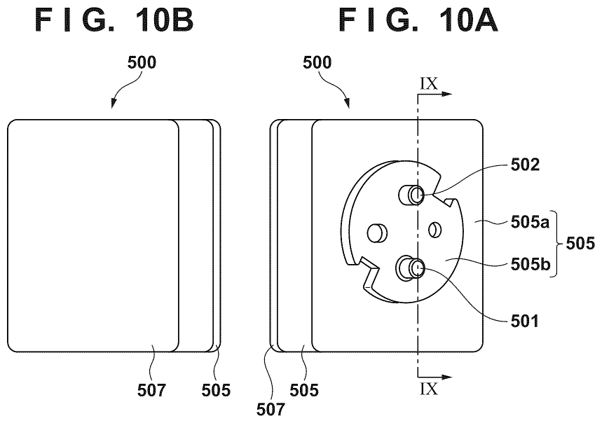

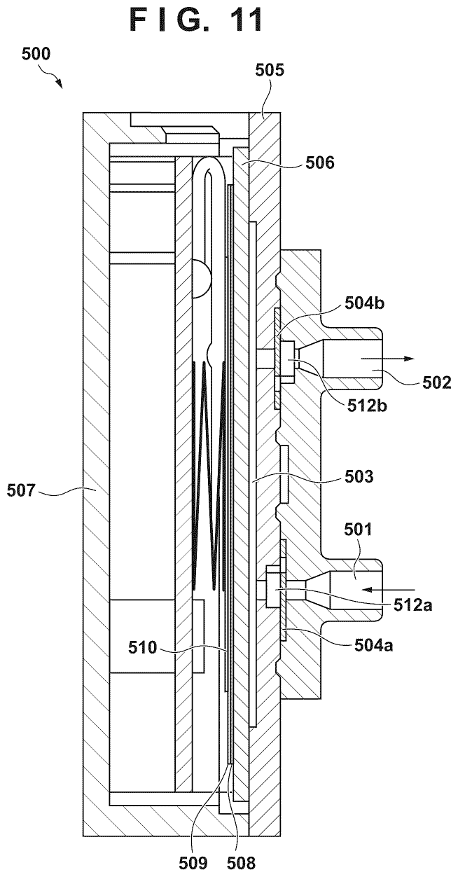

Next, the configuration and effects of the circulation pump 500 built in the liquid discharge head 1 described above will be described in detail with reference to FIGS. 10A, 10B, and 11.

FIGS. 10A and 10B are perspective views of the circulation pump 500. FIG. 10A is a perspective view of the front side of the circulation pump 500, and FIG. 10B is a perspective view of the back side of the circulation pump 500. The outer case of the circulation pump 500 is formed of a pump casing 505 and a cover 507 fixed to the pump casing 505. The pump casing 505 is formed of a casing portion body 505a and a flow path connection member 505b bonded and fixed to the outer surface of the casing portion body 505a. In each of the casing portion body 505a and the flow path connection member 505b, a pair of through holes communicating with one another are formed at two different positions. The pair of through holes formed on one position forms a pump supply hole 501, and the pair of through holes formed at the other position forms a pump ejection hole 502. The pump supply hole 501 is connected to the pump inlet flow path 170 connected to the second pressure control chamber 152, and the pump ejection hole 502 is connected to the pump outlet path 180 connected to the first pressure control chamber 122. The ink supplied from the pump supply hole 501 travels through a pump chamber 503 described below (see FIG. 11) and is ejected from the pump ejection hole 502.

FIG. 11 is a cross-sectional view taken along IX-IX of the circulation pump 500 illustrated in FIG. 10A. A diaphragm 506 is joined to the inner surface of the pump casing 505, and the pump chamber 503 is formed between the diaphragm 506 and the recess portion formed in the inner surface of the pump casing 505. The pump chamber 503 communicates with the pump supply hole 501 and the pump ejection hole 502 formed in the pump casing 505. Also, a check valve 504a is provided in an intermediate portion of the pump supply hole 501, and a check valve 504b is provided in an intermediate portion of the pump ejection hole 502. Specifically, the check valve 504a is disposed in a manner allowing for a portion of the check valve 504a to move in the left direction in the diagram in a space 512a formed in an intermediate portion of the pump supply hole 501. Also, the check valve 504b is disposed in a manner allowing for a portion of the check valve 504b to move in the right direction in the diagram in a space 512b formed in an intermediate portion of the pump ejection hole 502.

When the pressure in the pump chamber 503 decreases due to the diaphragm 506 moving position and the volume of the pump chamber 503 increasing, the check valve 504a separates from the opening of the pump supply hole 501 in a space 512a (in other words, moves to the left direction in the diagram). By the value 504a separating from the opening of the pump supply hole 501 in the space 512a, an open state in which the ink can flow in the pump supply hole 501 is realized. Also, when the pressured in the pump chamber 503 increases due to the diaphragm 506 moving position and the volume of the pump chamber 503 decreasing, the check valve 504a comes into tight contact with the wall surface at the periphery of the opening of the pump supply hole 501, and a closed state in which the ink flow in the pump supply hole 501 is blocked is realized.

On the other hand, when the pressure in the pump chamber 503 decreases, the check valve 504b comes into tight contact with the wall surface around the opening of the pump casing 505, and a closed state in which the ink flow in the pump ejection hole 502 is blocked is realized. Also, when the pressure in the pump chamber 503 increases, the check valve 504b separates from the opening of the pump casing 505 and moves to the space 512b side (in other words, moves in the right direction in the diagram), allowing the ink to flow in the pump ejection hole 502.

Note that any material that can deform in response to pressure in the pump chamber 503 can be used for each of the check valves 504a and 504b. For example, an elastic member made of EPDM or an elastomer or a film or thin plate of polypropylene or the like can be used. However, no such limitation is intended.

As described above, the pump chamber 503 is formed by joining the pump casing 505 and the diaphragm 506. Thus, when the diaphragm 506 deforms, the pressure of the pump chamber 503 changes. For example, when the diaphragm 506 moves to the pump casing 505 side (moves to the right side in the diagram) and the volume of the pump chamber 503 decreases, the pressure in the pump chamber 503 increases. This puts the check valve 504b located opposite the pump ejection hole 502 in the open state, and the ink in the pump chamber 503 is ejected. At this time, the check valve 504a located opposite the pump supply hole 501 comes into tight contact with the wall surface around the pump supply hole 501 to suppress a backflow of ink from the pump chamber 503 to the pump supply hole 501.

Also, in a case where the diaphragm 506 is moved in the direction for expanding the pump chamber 503, the pressure of the pump chamber 503 decreases. This puts the check valve 504a located opposite the pump supply hole 501 in the open state, and the ink is supplied to the pump chamber 503. At this time, the check valve 504b disposed in the pump ejection hole 502 comes into tight contact with the wall surface around the opening formed in the pump casing 505 to seal the opening. This suppresses a backflow of ink from the pump ejection hole 502 to the pump chamber 503.

In this manner, in the circulation pump 500, by changing the pressure in the pump chamber 503 via deformation of the diaphragm 506, the ink is suctioned and ejected. At this time, if bubbles enter in the pump chamber 503, even if the diaphragm 506 is moved, the pressure change in the pump chamber 503 is small due to the expansion and contraction of the bubbles. This leads to a decrease in the amount of liquid sent. For this, the pump chamber 503 is disposed parallel with the gravitational force so that the bubbles that have entered the pump chamber 503 easily gather at the upper portion of the pump chamber 503, and the pump ejection hole 502 is disposed higher than the center of the pump chamber 503. This can improve how easily bubbles are ejected from inside the pump and can stabilize the flow rate.

### Flow of Ink in Liquid Discharge Head

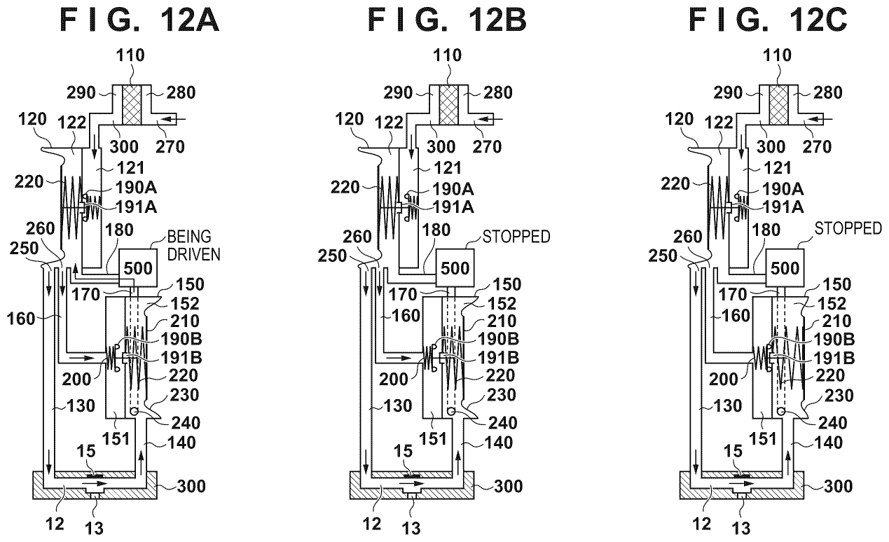

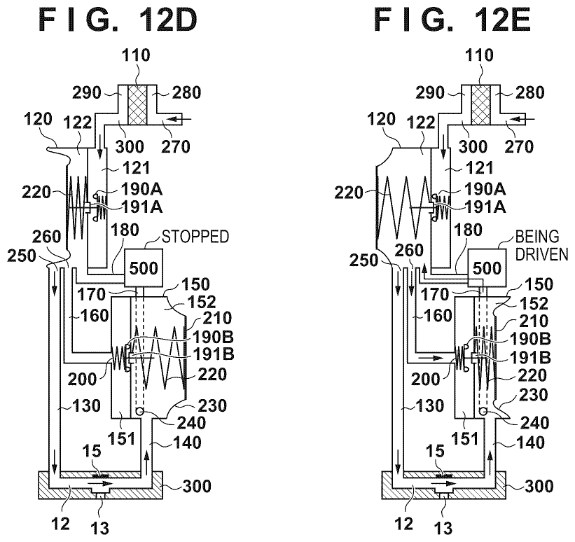

FIGS. 12A to 12E are diagrams for explaining the flow of ink in the liquid discharge head. The circulation of ink in the liquid discharge head 1 will be described with reference to FIGS. 12A to 12E. FIG. 12A schematically illustrates the flow of ink when the printing operation is performed. Note that the arrows in the diagrams indicate the ink flow. In the present embodiment, driving of both the external pump 21 and the circulation pump 500 is started when performing a printing operation. Note that the external pump 21 and the circulation pump 500 may be driven irrespective of a printing operation. Also, the external pump 21 and the circulation pump 500 may be driven in cooperation or may be independently driven.

During the printing operation, ink that has flowed from the first pressure control chamber 122 when the circulation pump 500 in an ON state (driven state) flows to the supply path 130 and the bypass flow path 160. The ink that has flowed to the supply path 130 travels through the discharge module 300 before flowing to the collection path 140, and then it is supplied to the second pressure control chamber 152.

The ink that has flowed from the first pressure control chamber 122 to the bypass flow path 160 travels through the second valve chamber 151 and flows to the second pressure control chamber 152. The ink that has flowed to the second pressure control chamber 152 travels through the pump inlet flow path 170, the circulation pump 500, and the pump outlet path 180 before flowing again to the first pressure control chamber 122. At this time, the control pressure from the first valve chamber 121 is set higher than the control pressure of the first pressure control chamber 122 on the basis of the relationship of Formula 2 described above. Accordingly, the ink in the first pressure control chamber 122 is supplied to the discharge modules 300 via the supply path 130 again while bypassing the first valve chamber 121. The ink that has flowed to the discharge module 300 travels through the collection path 140, the second pressure control chamber 152, the pump inlet flow path 170, the circulation pump 500, and the pump outlet path 180 and flows again to the first pressure control chamber 122. In this manner, the complete ink circulation in the liquid discharge head 1 is performed.

In the ink circulation described above, the circulation amount (flow rate) of ink in the discharge module 300 is determined by the difference in control pressure between the first pressure control chamber 122 and the second pressure control chamber 152. Then, the difference in pressure is set so that circulation amount can suppress an increase in the viscosity of the ink at or near the discharge port in the discharge module 300. Also, an amount of ink equal to the amount consumed by printing is supplied from the ink tank 2 to the first pressure control chamber 122 via the filter 110 and the first valve chamber 121. The mechanism for supplying consumed ink will be described in detail below. When ink decreases from the circulation path by an amount equal to the amount consumed by printing, the ink in the first pressure control chamber 122 also decreases. The internal volume of the first pressure control chamber 122 decreases in conjunction with the decrease of ink in the first pressure control chamber 122. A decrease in the internal volume of the first pressure control chamber 122 puts the communicating port 191A in the open state, causing ink to be supplied to the first pressure control chamber 122 from the first valve chamber 121. In the supplied ink, pressure loss occurs when travelling through the communicating port 191A from the first valve chamber 121, and when the ink flows to the first pressure control chamber 122, the ink switches from positive pressure to a negative pressure state. Then, since the ink flows from the first valve chamber 121 to the first pressure control chamber 122, the internal volume of the first pressure control chamber 122 increases and the communicating port 191A is put in the closed state. In this manner, according to the ink consumption, the communicating port 191A repeatedly switches between the open state and the closed state. Also, in a case where no ink is consumed, the communicating port 191A is maintained in the closed state.

FIG. 12B schematically illustrates the flow of ink immediately after the circulation pump 500 is put in an OFF state (stopped state) after the printing operation has ended. At the point in time when the circulation pump 500 turns to OFF after the printing operation has ended, the pressure of the first pressure control chamber 122 and the pressure of the second pressure control chamber 152 are both the control pressure of during the printing operation. Thus, depending on the pressure difference between the pressure of the first pressure control chamber 122 and the pressure of the second pressure control chamber 152, movement of ink will occur such as that illustrated in FIG. 12B. Specifically, a flow continues to occur in which the ink is supplied from the first pressure control chamber 122 to the discharge module 300 via the supply path 130 before travelling to the second pressure control chamber 152 via the collection path 140. Also, a flow continues to occur in which the ink flows from the first pressure control chamber 122 to the second pressure control chamber 152 travelling through the bypass flow path 160 and the second valve chamber 151.

The amount of ink that has moved from the first pressure control chamber 122 to the second pressure control chamber 152 via this ink flow is supplied from the ink tank 2 to the first pressure control chamber 122 via the filter 110 and the first valve chamber 121. Thus, the content amount in the first pressure control chamber 122 is maintained at a constant amount. As seen from the relationship of Formula 2 described above, when the content amount in the first pressure control chamber 122 is constant, the spring force F1 of the valve spring 200, the spring force F2 of the pressure adjusting spring 220, the pressure reception area S1 of the valve 190, and the pressure reception area S2 of the pressure plate 210 are maintained at a constant value. Thus, the pressure of the first pressure control chamber 122 is determined according to a change in the pressure (gauge pressure) P1 of the first valve chamber 121. Thus, in a case where there is no change in the pressure P1 of the first valve chamber 121, the pressure P2 of the first pressure control chamber 122 is maintained at the same pressure as the control pressure of during the printing operation.

On the other hand, the pressure of the second pressure control chamber 152 changes over time according to changes in the content amount following the flow of ink from the first pressure control chamber 122. Specifically, as illustrated in FIG. 12C, from the state of FIG. 12B until the communicating port 191 is put in the closed state and the second valve chamber 151 and the second pressure control chamber 152 are put in a non-communicating state, the pressure of the second pressure control chamber 152 changes as according to Formula 2. Thereafter, the pressure plate 210 and the valve shaft 190a are put in a non-contact state, and the communicating port 191 is put in the closed state. Then, as illustrated in FIG. 12D, ink flows from the collection path 140 to the second pressure control chamber 152. The pressure plate 210 and the flexible member 230 move position depending on the ink flow, and the pressure of the second pressure control chamber 152 changes according to Formula 4 until the internal volume of the second pressure control chamber 152 reaches the maximum. In other words, the pressure increases.

Note that when the state of FIG. 12C is realized, a flow in which the ink flows from the first pressure control chamber 122 to the second pressure control chamber 152 travelling through the bypass flow path 160 and the second valve chamber 151 no longer occurs. Thus, after the ink in the first pressure control chamber 122 is supplied to the discharge module 300 via the supply path 130, only the flow to the second pressure control chamber 152 via the collection path 140 occurs. As described above, the movement of the ink from the first pressure control chamber 122 to the second pressure control chamber 152 occurs according to the difference in pressure between the pressure in the first pressure control chamber 122 and the pressure in the second pressure control chamber 152. Thus, when the pressure in the second pressure control chamber 152 and the pressure in the first pressure control chamber 122 are equal, the movement of the ink stops.

Also, in a state where the pressure in the second pressure control chamber 152 and the pressure in the first pressure control chamber 122 become equal, the second pressure control chamber 152 expands to the state illustrated in FIG. 12D. In a case where the second pressure control chamber 152 has expanded as illustrated in FIG. 12D, a storage portion that can store the ink is formed in the second pressure control chamber 152. Note that the time taken from when the circulation pump 500 stops to when the state of FIG. 12D is transitioned to may change depending on the shape and size of the flow paths and the characteristics of the ink. However, the transition takes approximately 1 to 2 minutes. When the circulation pump 500 is driven from the state illustrated in FIG. 12D with the ink stored in the storage portion, the ink in the storage portion is supplied to the first pressure control chamber 122 via the circulation pump 500. Thus, as illustrated in FIG. 12E, the ink amount of the first pressure control chamber 122 increases, and the flexible member 230 and the pressure plate 210 move position in the expanding direction. Then, when the circulation pump 500 continues to be driven, as illustrated in FIG. 12A, the state in the circulation path changes.

Note in the foregoing description, FIG. 12A is used to be described an example of when a printing operation is performed. However, as described above, the ink may be circulated without a printing operation. In this case, the ink flows as illustrated in FIGS. 12A to 12E according to the driving and stopping of the circulation pump 500.

Also, in the example of the present embodiment described above, the communicating port 191B in the second pressure adjusting unit 150 is put in the open state when the circulation pump 500 is driven and ink circulation is performed and is put in the closed state when the ink circulation is stopped. However, no such limitation is intended. The control pressure may be set such that the communicating port 191B in the second pressure adjusting unit 150 is put in the closed state even in a case where the circulation pump 500 is driven and ink circulation is performed. This will be described in detail below. The bypass flow path 160 that connects the first pressure adjusting unit 120 and the second pressure adjusting unit 150 is provided so that in a case where a negative pressure in the circulation path is greater than a predetermined value, for example, the discharge module 300 is not affected by it. When the ink characteristics (for example, viscosity) changes due to a change in the environment temperature, the pressure loss in the circulation path also changes. For example, when the ink viscosity is reduced and the pressure loss portion in the circulation path decreases, the negative pressure in the circulation path may become greater than the predetermined value. When the negative pressure in the discharge module 300 is greater than the predetermined value, external air is taken into the circulation path from the discharge port 13 and the meniscus of the discharge port 13 may be damaged, causing discharge to be unable to be normally performed. Thus, in the present embodiment, the bypass flow path 160 is formed in the circulation path. By providing the bypass flow path 160, in a case where the negative pressure is greater than the predetermined value, ink also flows through the bypass flow path 160. This maintains the pressure of the discharge module 300 at a certain value. Accordingly, for example, the control pressure may be configured such that the communicating port 191 in the second pressure adjusting unit 150 is maintained in the closed state even while the circulation pump 500 is driven. Then, the control pressure in the second pressure adjusting unit 150 may be set such that, in a case where the negative pressure is greater than the predetermined value, the communicating port 191 in the second pressure adjusting unit 150 is put in the open state.

Also, the discharge operation by the discharge element 15 may cause a pressure variation in the circulation path. This is because, conjunction with the discharge operation, a force for taking ink into the pressure chamber is generated. Accordingly, for example, the communicating port 191 may be put in the open state upon the discharge operation being performed even in a case where the communicating port 191 in the second pressure adjusting unit 150 is configured to be in the closed state while the circulation pump 500 is driven. For example, in a case where the printing duty continues to be high-duty printing, the negative pressure of the pressure chamber increases. When the negative pressure of the pressure chamber increases, the ink backflows to the pressure chamber (discharge port 13) from the collection path 140 side as well. The backflow causes a decrease in the ink of the second pressure control chamber 152, reducing the size of the second pressure control chamber 152. As a result, the communicating port 191 in the second pressure adjusting unit 150 is put in the open state. In this case, in the pressure chamber, the ink of the supply path 130 and the ink of the collection path 140 are filled and discharged. Note that the backflow of ink caused when the printing duty is high-duty is a phenomenon caused due to the bypass flow path 160 being provided. Also, in the example described above, the communicating port 191 in the second pressure adjusting unit 150 is put in the open state in response to an ink backflow. However, an ink backflow may be caused when the communicating port 191 in the second pressure adjusting unit 150 is in the open state. Also, even with a configuration not including the second pressure adjusting unit 150, the ink backflow may occur with the bypass flow path 160 provided.

### Configuration of Discharge Unit

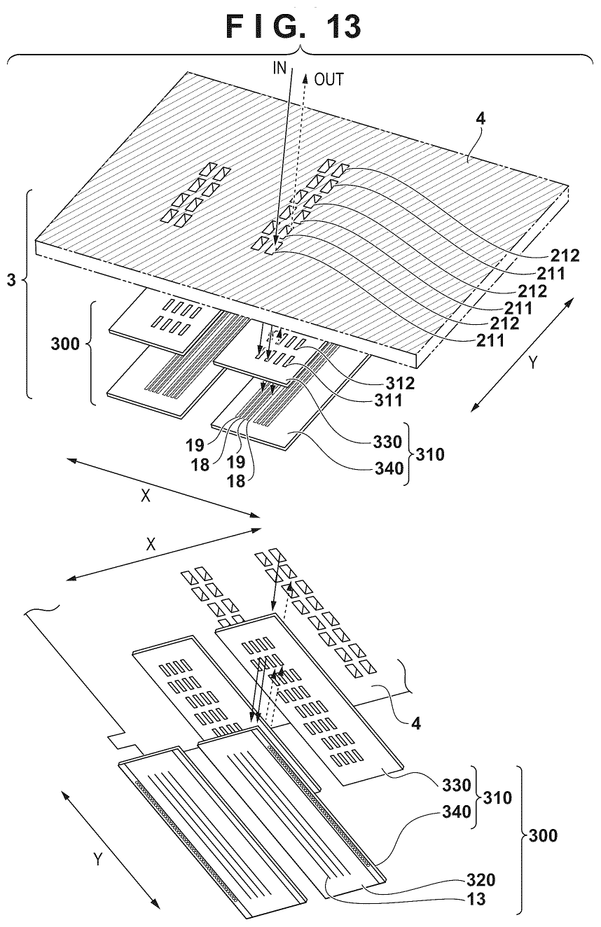

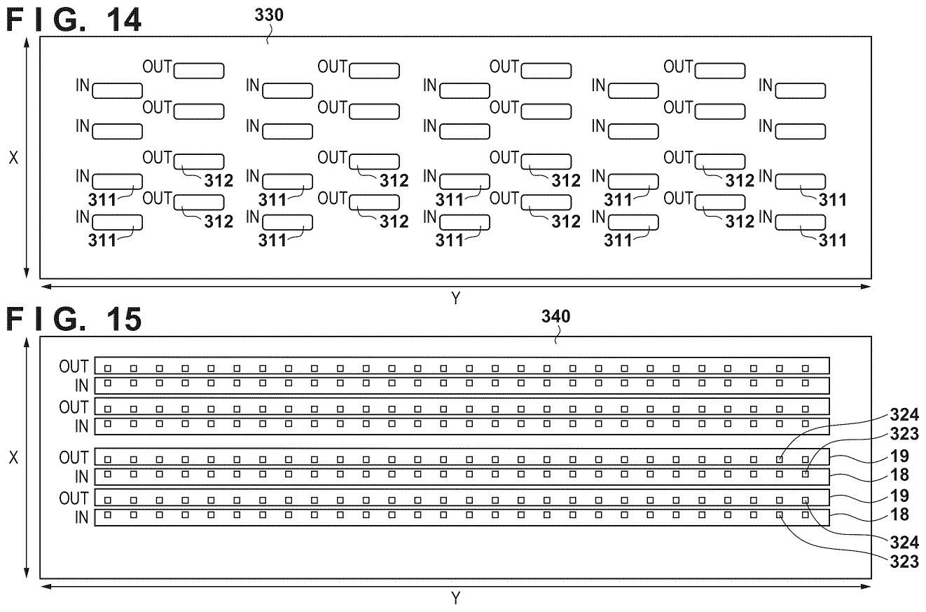

FIGS. 13A and 13B are schematic views illustrating the circulation path corresponding to one color in the discharge unit 3 according to the present embodiment. FIG. 13A is an exploded perspective view of the discharge unit 3 as seen from the first support member 4 side. FIG. 13B is an exploded perspective view of the discharge unit 3 as seen from the discharge module 300 side. Note that the IN and OUT arrows in the diagrams indicate the flow of the ink. Here, the flow of ink of only one color will be described, but ink of the other colors flow in a similar manner. Also, for visual clarity, the second support member 7 and the electrical wiring member 5 are omitted from FIGS. 13A and 13B, and these are also omitted from the following description of the configuration of discharge unit. Also, for the first support member 4 illustrated in FIG. 13A, the cross section taken along XI-XI of FIGS. 5A and 5B are illustrated. The discharge module 300 includes a discharge element substrate 340 and an opening plate 330. FIG. 14 is a diagram illustrating the opening plate 330, and FIG. 15 is a diagram illustrating the discharge element substrate 340.

The discharge unit 3 is supplied with ink from the circulation unit 54 via the joint member 8 (see FIGS. 5A and 5B). The ink path from after travelling through the joint member 8 to returning back to the joint member 8 will now be described. Note that the joint member 8 is omitted from the diagrams described below.

The discharge module 300 includes the discharge element substrate 340 and the opening plate 330, and by overlapping and joining these together to connect the flow paths of each ink, the discharge module 300 is formed. The discharge module 300 is supported on the first support member 4. By supporting the discharge module 300 on the first support member 4, the discharge unit 3 is formed. The discharge element substrate 340 includes the discharge port forming member 320. The discharge port forming member 320 includes a plurality of discharge port rows including the plurality of discharge ports 13 formed in rows. A portion of the ink supplied via the ink flow path in the discharge module 300 is discharged from the discharge ports 13. The non-discharged ink is collected via the ink flow path in the discharge module 300.

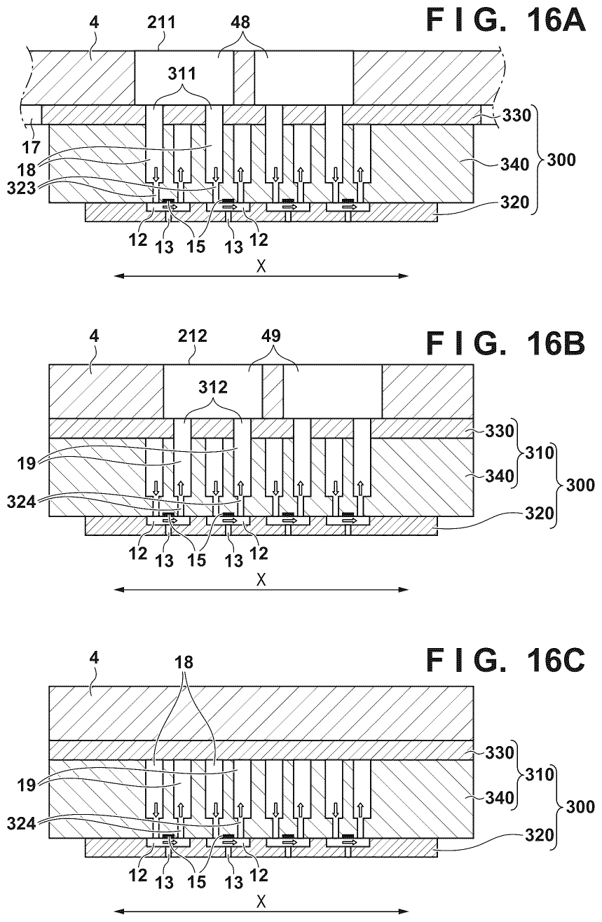

As illustrated in FIGS. 13A and 13B and 14, the opening plate 330 includes a plurality of ink supply ports 311 arranged in rows and a plurality of ink collection ports 312 arranged in rows. As illustrated in FIGS. 15 and 16A to 16C, the discharge element substrate 340 includes a plurality of supply connection flow paths 323 arranged in rows and a plurality of collection connection flow paths 324 arranged in rows. Also, the discharge element substrate 340 includes the individual supply paths 18 that communicate with the plurality of supply connection flow paths 323 and the individual collection paths 19 that communicate with the plurality of collection connection flow paths 324. The ink flow path in the discharge unit 3 is formed by connecting the ink supply path 48 provided in the first support member 4, the ink collection path 49 (see FIGS. 5A and 5B), and the flow path provided in the discharge module 300. A support member supply port 211 is a cross-sectional opening forming the ink supply path 48, and a support member collection port 212 is a cross-sectional opening forming the ink collection path 49.

The ink to be supplied to the discharge unit 3 is supplied to the ink supply path 48 (see FIG. 5A) of the first support member 4 from the circulation unit 54 (see FIG. 5A) side. The ink that has flowed through the support member supply port 211 in the ink supply path 48 is supplied to the individual supply paths 18 of the discharge element substrate 340 via the ink supply paths 48 (see FIG. 5A) and the ink supply ports 311 of the opening plate 330 and enters the supply connection flow paths 323. The flow path up until here corresponds to the flow path on the supply side. Thereafter, the ink flows to the collection connection flow paths 324 of the collection side flow path via the pressure chambers 12 (see FIG. 5B) of the discharge port forming member 320. The ink flow in the pressure chamber 12 will be described below in detail.

In the collection side flow path, the ink that has entered the collection connection flow paths 324 flows to the individual collection paths 19. Thereafter, the ink flows from the individual collection paths 19 to the ink collection paths 49 of the first support member 4 via the ink collection ports 312 of the opening plate 330 and is collected at the circulation unit 54 via the support member collection ports 212.

The region of the opening plate 330 where there are no ink supply ports 311 and no ink collection ports 312 corresponds to a region of the first support member 4 for separating the support member supply ports 211 and the support member collection ports 212. Also, this region of the first support member 4 does not include openings. Such a region is used as the bonding region in the case of bonding together the discharge module 300 and the first support member 4.

In the opening plate 330 of FIG. 14, a plurality of rows of openings arranged in the X direction are provided in rows in the Y direction, and the openings for supply (IN) and the openings for collection (OUT) are alternately arranged in the Y direction offset by a half pitch in the X direction. In the discharge element substrate 340 of FIG. 15, the individual supply paths 18 that communicate with the plurality of supply connection flow paths 323 arranged in rows in the Y direction and the individual collection paths 19 that communicate with the plurality of collection connection flow paths 324 arranged in rows in the Y direction are alternately arranged in the X direction. The individual supply paths 18 and the individual collection paths 19 are divided per ink type, and also the arrangement number of the individual supply paths 18 and the individual collection paths 19 is determined according to the number of discharge port rows of each color. Also, the number of supply connection flow paths 323 and the collection connection flow paths 324 disposed corresponds to the number of discharge ports 13. Note that this does not need to be a 1 to 1 correspondence, and one supply connection flow path 323 and collection connection flow path 324 may correspond to a plurality of discharge ports 13.

By overlapping the opening plate 330 and the discharge element substrate 340 in this manner to connect the ink flow paths, the discharge module 300 is formed, and by supporting this on the first support member 4, the ink flow path including the supply paths and the collection paths described above are formed.

FIGS. 16A to 16C are cross-sectional views illustrating the ink flow at different portions of the discharge unit 3. FIG. 16A illustrates the cross section of a portion of the discharge unit 3 where the ink supply path 48 and the ink supply ports 311 communicate, and FIG. 16B illustrates a cross section of a portion of the discharge unit 3 where the ink collection path 49 and the ink collection port 312 communicate. Also, FIG. 16C illustrates the cross section of a portion where the ink supply port 311 and the ink collection port 312 do not communicate with the flow path of the first support member 4.

As illustrated in FIG. 16A, in the supply path for supplying ink, ink is supplied from the portion where the ink supply paths 48 of the first support member 4 and the ink supply ports 311 of the opening plate 330 overlap and communicate. Also, as illustrated in FIG. 16B, in the collection path for collecting ink, ink is collected from the portion where the ink collection paths 49 of the first support member 4 and the ink collection ports 312 of the opening plate 330 overlap and communicate. Also, as illustrated in FIG. 16C, the discharge unit 3 partially includes a region where no openings are formed in the opening plate 330. In such a region, ink is not supplied or collected, but as illustrated in FIG. 16A, ink is supplied in the region where the ink supply ports 311 are provided, and as illustrated in FIG. 16B, ink is collected in the region where the ink collection ports 312 are provided. Note that in the example of the present embodiment described above, the configuration using the opening plate 330. However, a configuration without the opening plate 330 may be used. For example, a configuration may be used in which a flow path corresponding to the ink supply path 48 and the ink collection path 49 is formed in the first support member 4 and the discharge element substrate 340 is joined to the first support member 4.

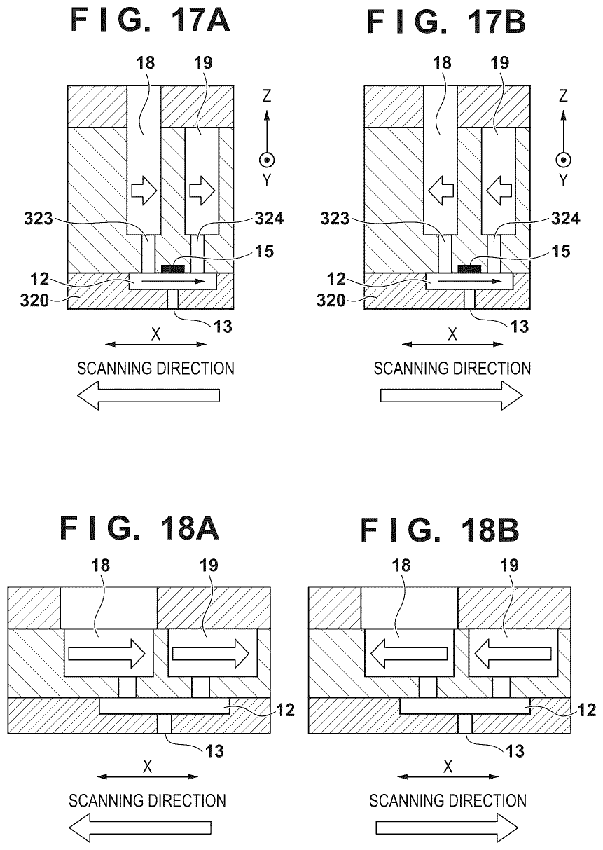

FIGS. 17A and 17B are cross-sectional views illustrating the area of the discharge module 300 near the discharge port 13. FIGS. 18A and 18B are cross-sectional views illustrating, as a comparative example, a discharge module with a configuration in which the individual supply path 18 and the individual collection path 19 are expanded in the X direction. Note that the thick arrows illustrated in the individual supply paths 18 and the individual collection paths 19 in FIGS. 17A, 17B, 18A, and 18B indicate the oscillation of ink in a configuration using the serial liquid discharge apparatus 50. The ink supplied to the pressure chambers 12 via the individual supply paths 18 and the supply connection flow paths 323 is discharged from the discharge ports 13 by the discharge elements 15 being driven. In a case where the discharge elements 15 are not driven, the ink is collected from the pressure chambers 12 at the individual collection paths 19 via the collection connection flow paths 324, which are collection paths.

With a configuration using the serial liquid discharge apparatus 50, in the case of discharging from ink circulating in this manner, the discharge of ink is substantially affected by the ink oscillation in the ink flow paths due to the scanning by the liquid discharge head 1. Specifically, the effects of the ink oscillation in the ink flow paths show up as differences in the ink discharge amount and shifts in the discharge direction. As illustrated in FIGS. 18A and 18B, in a case where the individual supply path 18 and the individual collection path 19 have a cross-sectional shape with a wide width in the X direction, the scanning direction, the ink in the individual supply path 18 and the individual collection path 19 easily receive inertial forces in the scanning direction so that the link greatly oscillates. This leads to a possibility of the ink oscillation affecting the ink discharge from the discharge ports 13. Also, if the individual supply path 18 and the individual collection path 19 are wide in the X direction, the distance between colors in increased, which leads to a possibility of the printing efficiency decreasing.

There, the individual supply path 18 and the individual collection path 19 according to the present embodiment have a configuration that extends in the Y direction and also extends in the Z direction perpendicular to the X direction, the scanning direction, in the cross section illustrated in FIGS. 17A and 17B. With this configuration, each flow path width in the scanning direction of the individual supply path 18 and the individual collection path 19 can be decreased in size. Decreasing the size of each flow path width in the scanning direction of the individual supply path 18 and the individual collection path 19 decreases the ink oscillation caused by inertial forces (black thick arrows in the diagrams) acting in the opposite direction to the scanning direction acting on the ink in the individual supply path 18 and the individual collection path 19 during scanning. This can suppress the effects of ink oscillation on ink discharge. Also, increasing the cross-sectional area by extending the individual supply path 18 and the individual collection path 19 in the Z direction leads to a reduction in pressure loss in the flow path.

As described above, with this configuration, by decreasing the size of each flow path width in the scanning direction of the individual supply path 18 and the individual collection path 19 to ink oscillation in the individual supply path 18 and the individual collection path 19 during scanning is decreased, but the oscillation is not completely removed. Regarding this, to suppress a difference in the discharge between each ink type that may be caused even by the reduced oscillation, in the present embodiment, the individual supply path 18 and the individual collection path 19 are configured to be disposed at a position overlapping in the X direction.

As described above, in the present embodiment, the supply connection flow paths 323 and the collection connection flow paths 324 are provided corresponding to the discharge ports 13, and the supply connection flow paths 323 and the collection connection flow paths 324 have a correspondence relationship in which they are arranged next to one another in the X direction on either side of the discharge ports 13. Thus, if the individual supply path 18 and the individual collection path 19 have a portion where they do not overlap in the X direction and the correspondence relationship between the supply connection flow paths 323 and the collection connection flow paths 324 in the X direction collapses, this affects the ink flow in the pressure chambers 12 in the X direction and the discharge. If the effects of ink oscillation are added to this, there is a possibility of the ink discharge at each discharge port being further affected.

Thus, by arranging the individual supply path 18 and the individual collection path 19 at positions overlapping one another in the X direction, the ink oscillation during scanning is roughly the same in the individual supply path 18 and the individual collection path 19 at any position in the Y direction where the discharge ports 13 are arranged. As a result, a large variation in the pressure difference between the individual supply path 18 side and the individual collection path 19 side in the pressure chambers 12 can be avoided, and stable discharge can be performed.

Also, in the liquid discharge head where ink is circulated, the flow path for supplying ink to the liquid discharge head and the flow path for collection may be configured of the same flow path. However, in the present embodiment, the individual supply path 18 and the individual collection path 19 are separate flow paths. Also, the supply connection flow paths 323 and the pressure chambers 12 are connected, the pressure chambers 12 and the collection connection flow paths 324 are connected, and ink is discharged from the discharge ports 13 of the pressure chambers 12. In other words, the pressure chamber 12, which is a path joining the supply connection flow path 323 and the collection connection flow path 324, has a configuration which includes the discharge port 13. Thus, in the pressure chamber 12, ink flow occurs from the supply connection flow path 323 side to the collection connection flow path 324 side, leading to efficient circulation of the ink in the pressure chamber 12. With efficient circulation of the ink in the pressure chamber 12, the ink of the pressure chamber 12 easily affected by evaporation of the ink from the discharge port 13 can be maintained in a fresh state.

Also, with the two flow paths, the individual supply path 18 and the individual collection path 19, being connected to the pressure chamber 12, ink can be supplied from both flow paths if it becomes necessary to discharge at a high flow rate. In other words, compared to a configuration in which the ink supply and collection are formed by only one flow path, the configuration according to the present embodiment is advantageous in that circulation can be efficiently performed as well as being able to cope with a high flow rate discharge.

Also, by disposing the individual supply path 18 and the individual collection path 19 at positions closer to one another in the X direction, the effects of ink oscillation can be resisted more. Preferably, the distance between the flow paths ranges from 75 μm to 100 μm.

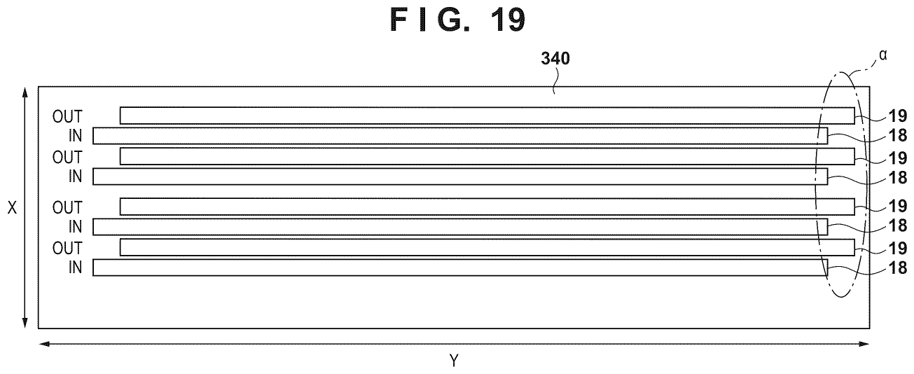

FIG. 19 is a diagram illustrating the discharge element substrate 340 according to a comparative example. Note that in FIG. 19, the supply connection flow paths 323 and the collection connection flow paths 324 are omitted. Since the ink that has received thermal energy from the discharge element 15 at the pressure chamber 12 flows into the individual collection path 19, the temperature of the flowing ink is higher than the temperature of the ink in the individual supply path 18. At this time, in the comparative example, in a portion of the discharge element substrate 340 in the X direction, there is a portion where only the individual collection paths 19 exist, as seen with a portion a surrounded by the dot-dash line of FIG. 19. In this case, this portion experiences a localized temperature increase, causing a temperature unevenness in the discharge module 300 that may affect discharge.

Ink with a relatively lower temperature than the individual collection path 19 flows through the individual supply path 18. Thus, when the individual supply path 18 and the individual collection path 19 are adjacent to one another, in this vicinity, the temperatures of the individual supply path 18 and the individual collection path 19 partially cancel out one another. This suppresses in increase in the temperature. Thus, the individual supply path 18 and the individual collection path 19 preferably have substantially the same length, are located at a position overlapping in the X direction, and are adjacent to one another.

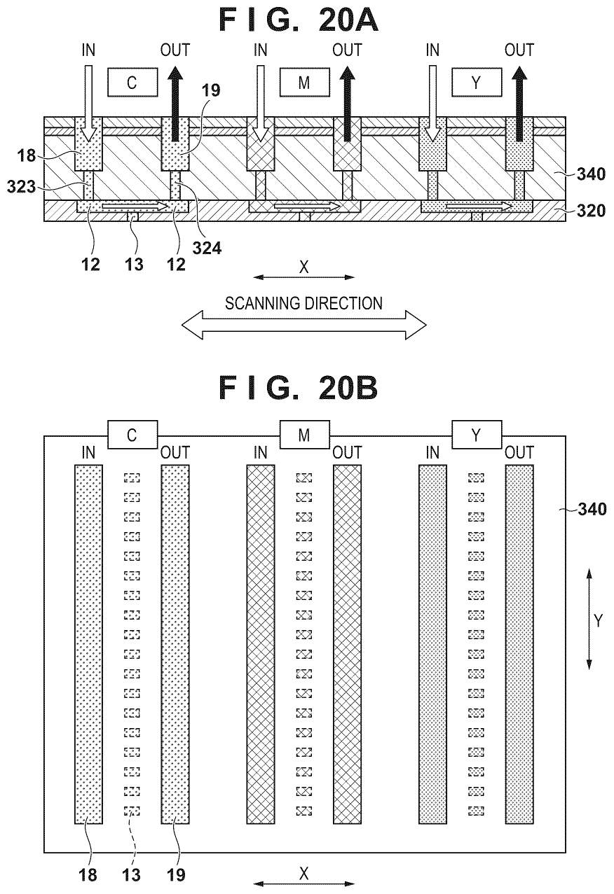

FIGS. 20A and 20B are diagrams illustrating the flow path configuration of the liquid discharge head 1 associated with the ink of three colors, cyan (C), magenta (M), and yellow (Y). As illustrated in FIG. 20A, a circulation path for each type of ink is provided in the liquid discharge head 1. The pressure chambers 12 are provided extending in the X direction, which is the scanning direction of the liquid discharge head 1. Also, as illustrated in FIG. 20B, the individual supply path 18 and the individual collection path 19 are provided along the discharge port row including the row of discharge ports 13, and the individual supply path 18 and the individual collection path 19 are provided extending in the Y direction on either side of the discharge port row.

Next, a method for determining the ink to use and the ink to not use in image formation according to the input image and printing conditions and a method for determining whether to perform circulation during a printing operation according to the present embodiment will be described. Accordingly, an increase in the viscosity of ink not used in image formation in the nozzle can be suppressed, and faulty discharge when the ink is used again in image printing can be suppressed.

Firstly, the concentration of the ink in the nozzle during a printing operation will be described. When a printing operation starts, the cap 61 in contact with the liquid discharge head 1 is removed, exposing the nozzles 402 (see FIG. 3) to the atmosphere. Thus, during image formation, the moisture in the ink of the nozzle gradually evaporates into the atmosphere, with concentration advancing. In the ink concentrated due to moisture evaporation, the ratio of components other than water, such as color material, resin, and solvent, is increased relative to the initial state, leading to an increase in the viscosity of the ink at or near the nozzle.

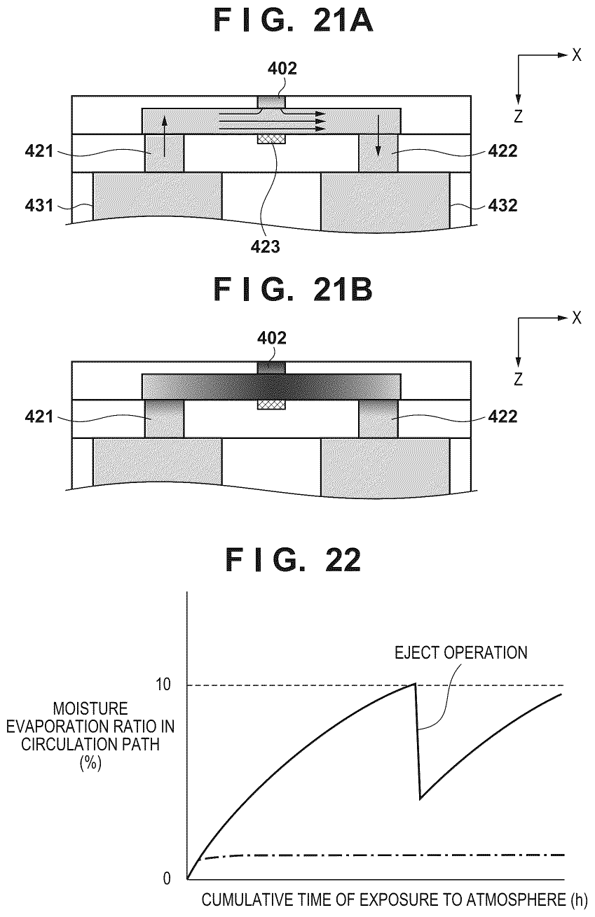

FIG. 21A is a schematic view illustrating the concentration in a circulation state of when the nozzle 402 is exposed to the atmosphere. The ink flow is indicated by the arrows, and the ink concentration level is indicated by the shading. In a case where ink in the nozzle is circulated during a printing operation, moisture evaporation from the ink liquid surface (meniscus) of the nozzle advances, with the ink at the surface layer portion being concentrated. However, at the rear side, the ink is flowing due to circulation, and thus ink in a non-concentrated state is continuously supplied. At the surface layer portion, the circulation flow rate is low with the ink stagnating. Thus, over time, the evaporation of the concentrated ink at the surface layer further advances. However, moisture is supplied with non-concentrated ink flowing in the lower layer mixing with the ink at the boundary portion. Thus, the moisture is not completely lost from the ink at the surface layer portion. Accordingly, when the non-concentrated ink at the lower layer portion is foamed by driving the heater of the nozzle, the ink concentrated at the surface layer portion is discharged out of the nozzle by this energy. When circulation for a long time in only a non-discharge state is performed, the ink at the surface layer portion is discharged in an advanced concentration state. This causes an increase in viscosity which may lead to a decrease in discharge speed, a bend in the discharge direction, or other discharge faults. In such a case, by performing a preliminary discharge of a small amount at a region outside of the image formation region, the concentrated ink at the surface layer can be ejected, and the discharge performance can be restored.

The ink in the circulation path is homogenized while flowing in the circulation path by being partially mixed with the ink concentrated at or near the nozzle. Thus, the moisture ratio gradually decreases and the concentration advances. FIG. 22 is a graph illustrating the shift in the moisture evaporation ratio of the ink in the circulation path during a printing operation. It shows that a high moisture evaporation ratio indicates that ink concentration has advanced. The concentration speed is not only dependent on the moisture evaporation speed from the nozzle but also the opening area of the nozzle, the number of nozzles, the flow rate of the circulation, and the ink capacity of the circulation path. In particular, since the ink viscosity is reduced and the discharge characteristics are stabilized by warming the region at or near the nozzle to a certain temperature during the printing operation, the evaporation speed of the ink warmed in the nozzle is faster than cases where this is not performed.

In the case of using ink in image formation, an amount of ink equal to that discharged from the nozzle is newly supplied to the liquid discharge head 1. Thus, as indicated in the graph by the broken line in FIG. 22, the ink concentration level is saturated when the ink consumption rate and the moisture evaporation speed in the circulation path are balanced. However, in the case of the ink that is unused in image formation, as indicated in the graph by the solid line in FIG. 22, just by performing a preliminary discharge of a small amount, the concentration speed of the ink in the circulation path cannot be suppressed, and the ink concentration in the circulation path greatly increases over time.

When the ink concentration level in the circulation path increases, discharge characteristics degraded due to an increase in viscosity and color deviation due to an increase in the color material concentration affect the image formation. In this case, the ink concentration level in the circulation path needs to be reduced by ejecting the concentrated ink and supplying new ink so that the ink in the circulation path is homogenized. Thus, in a case where the ink concentration level is greater than a tolerance range, the ink is suctioned from the corresponding nozzle using the cap 61 or the ink is discharged from the nozzle to allow new ink to enter in the circulation path and reduce the concentration level.

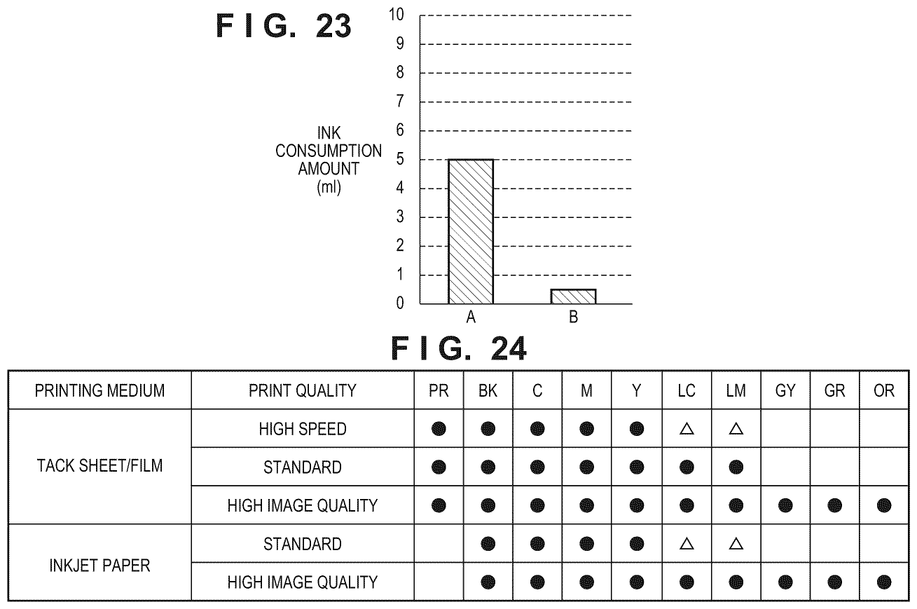

In the example of the ink not used in image formation indicated by a solid line in FIG. 22, control of an eject operation is performed so that the moisture evaporation ratio becomes 10% or greater and control of an eject operation is performed so that the ink concentration level is reduced. Note that all of the concentrated ink does not need to be ejected in this operation, and the amount ejected only needs to be sufficient to reduce the concentration level to a range in which the discharge characteristics and image formation are not affected. In the liquid discharge head 1 according to the present embodiment, the circulation path content amount is approximately 10 ml. Thus, the amount to eject when reducing the concentration level is set to 5 ml or greater. In the graph of FIG. 23, A indicates the consumption amount.

In a case where the ink in the nozzle is not circulated during a printing operation, the moisture gradually evaporates from the ink in the nozzle during the printing operation, but the ink in the circulation path does not move. Thus, the ink closer to the nozzle is put in a more concentrated state. FIG. 21B is a schematic view illustrating the ink concentration state when ink is not circulated with the nozzle exposed to the atmosphere. If the amount of time the nozzle has been exposed to the atmosphere is short and the ink concentration level in the nozzle is low, the concentrated ink can be ejected via discharge. However, in a case where the nozzle has been exposed to the atmosphere for a long time and the ink concentration level in the nozzle is high, the viscosity of all the ink in the nozzle increases. In this state, sufficient foaming energy cannot be generated to discharge the concentrated ink even by attempting to discharge by driving the heater. However, the ink at a position separated from the nozzle is hardly affected by evaporation at or near the nozzle, and the moisture evaporation ratio when the entire circulation path is considered is small.

In the example of a concentrated state illustrated in FIG. 21B, the ink concentration is advancing in regions up to a flow inlet 421 and a flow outlet 422, and the ink to the rear of a common flow path 431 is in a non-concentrated state. Thus, in a case where unused ink is in a state where it cannot be discharged due to concentration, by sucking out concentrated ink at or near the nozzle via suction operation using the cap 61, the discharge performance can be restored with only a small ink consumption.

The volume of the flow path around the nozzle and the common flow path 431 is approximately 20 μl, but in the present embodiment, for stable suction at the cap, the suction amount is approximately 0.5 ml. This consumption amount is illustrated in FIG. 23B. Also, the concentration level in the circulation path is maintained in a low state. Even if the suction operation cannot completely remove the concentrated ink, by restoring the state to one in which circulation can be performed, the small amount of remaining concentrated ink is homogenized with the ink in the circulation path. Thus, the effects of the concentration level on the ink in the circulation path are minimal, and the effects on the discharge characteristics and image formation are suppressed.

However, when the temperature increases, unless the ink in the nozzle is circulated, the moisture evaporation speed tends to increase, the concentration tends to advance, and there is a possibility of a change in the physical properties of the ink occurring due to the temperature effects. For example, when aggregation of pigment or resin in the concentrated ink advances, the solids in the nozzle are put in a separated state, and when the clumps grow large, they may block the nozzle. To prevent this, the ink in the nozzle needs to be ejected before the aggregation of solids begins or the concentration in the nozzle needs to be suppressed by circulation. Ink is difficult to eject via discharge when the concentration is in an advanced state, and ejecting ink using other nozzles together via suction using the cap leads to an increase in the ink consumption amount. Thus, with the configuration according to the present embodiment in which ink in the nozzle can be circulated, it is preferable to circulate the ink under the condition that the temperature increases during the printing operation.

Accordingly, with an ink with a possibility of increasing in temperature during a printing operation, circulation in the nozzle needs to be continued. Thus, by circulating not only the ink used during the printing operation but also the ink in the same chip, the negative effects of a change in the physical properties of the ink are suppressed. Also, by not circulating ink with no possibility of a temperature increase unless necessary and suctioning the concentrated ink in the nozzle when use is resumed, the amount of ink to discard is reduced, and the ink concentration in the circulation path can be suppressed.

In the example of the present embodiment described herein, whether or not to perform circulation of each ink during a printing operation is determined by a printing condition.

FIG. 24 is a table illustrating the correspondence between the ink to be used in image formation and printing conditions of the input image data. The ink marked with a “●” in the table for print quality is used in the image formation, and the others are not used. The ink marked with a “Δ” are not used in the image formation, but must be circulated.

As illustrated in FIG. 24, with a non-absorbent printing medium such as a tack sheet or film, the moisture and the solvent of the color ink that lands on the printing medium are not absorbed by the printing medium. Thus, if a large amount of ink is used, movement cannot be suppressed with the surface tension between the printing medium and the ink, causing bleeding. Thus, with a non-absorbent printing medium, a primer is reacted with the ink to increase viscosity and suppress movement. However, in the case of a printing medium such as inkjet paper that is formed with an ink receiving layer on the front surface of the printing medium, the moisture and solvent can be absorbed in the receiving layer, removing the need to use a primer.

Also, in a printing mode that prioritizes image printing speed, to reduce the processing amount for generating print data for each ink color from the input image data and to prevent a reduction in print speed, only the four basic colors, cyan, magenta, yellow, and black, are used. In a printing mode that prioritizes image quality, to improve color development and reduce graininess, light color ink including light cyan, light magenta, and gray are used and spot colors including green and orange are used. In a printing mode between these two, for example, the basic colors, light cyan, and light magenta are selected as the ink to use.

Note in the ink configuration according to the present embodiment, the light color gray and the spot colors green and orange are used. However, other spot colors including red, blue, and violet may be used, and clear ink used in gloss control and white ink used for representing white on a transparent film or the like may be used. Also, the allocation and arrangement order of the ink colors of each head are not limited to that described in the present embodiment. Also, in the example configuration of the present embodiment described above, the ink to use is selected according to the printing mode. However, in the case of a format where the image data is input as data corresponding to ink, the ink to use may be determined according to the presence or absence of the data.

The presence or absence for ink use is determined for each chip 403 for the ink to use selected in this manner. Since the basic colors are used in any printing condition, two chips 403 of the liquid discharge head 110 are always used. The chip 403 of the liquid discharge head 111L using only primer is not used for inkjet paper and is used for other printing media. The liquid discharge head 111R is used only for high image quality printing modes.

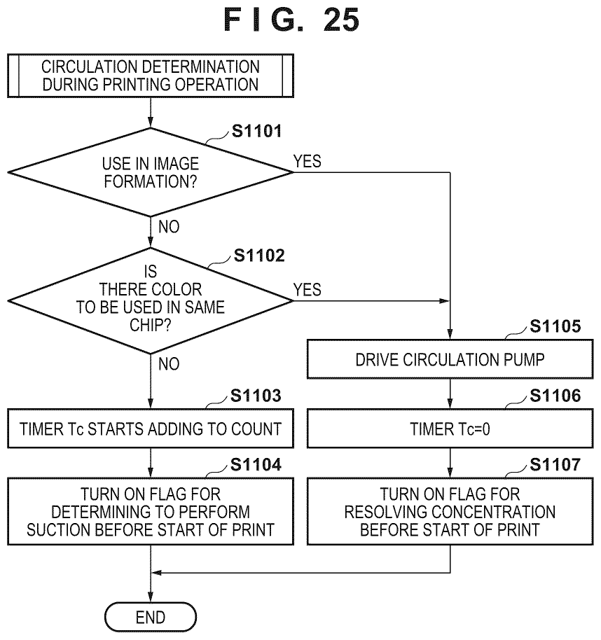

This flowchart is illustrated in FIG. 25.

In FIG. 25, firstly, in step S1101, whether or not the ink is to be used in image formation is determined, and in step S1102, from among the inks determined to not be used, whether or not there is ink to be used on the same chip is determined. In step S1105, for the ink determined to be used in steps S1101 and S1102, the circulation pump is driven. Also, in the present embodiment, a timer Tc is prepared for measuring the time during which the ink concentration in the nozzle advances with the cap open and in a non-circulating state. Note that while the circulation pump is driven, the timer Tc is 0. In some cases, for example, an ink that was not used in the previous printing operation and is not being circulated may have 0 for the timer at the point in time that the printing operation is started. In this case, when the ink is used again in image formation, circulation is performed and the concentrated ink in the nozzle is removed. Thus, the timer Tc is reset in step S1106.

However, for ink not to be used in image formation and without a color to be used on the same chip, the circulation pump is not driven, and in step S1103, the timer Tc cumulatively adds to the current count value without resetting. This is because when it is selected to not perform circulation for all of the printing operations in the case of a plurality of printing operations, the ink in the nozzle is left in its concentrated state without circulation. Note that the timer Tc is reset in a case where a recovery operation is performed via cap suction and the ink with increased viscosity in the nozzle is ejected.

In this manner, whether or not to perform circulation during the printing operation is determined. However, lastly, on the basis of whether or not circulation has been performed during the printing operation, flag processing for the required recovery processing is executed before the next printing operation starts.

In a case where circulation has not been performed during the printing operation and the concentration in the nozzle has advanced without circulation being performed for a long time, the concentrated ink needs to be ejected via suction. Thus, in step S1104, a flag for determining to perform a suction operation is set to ON. In a case where circulation is performed during the printing operation and the ink concentration in the circulation path has advanced, a discharge operation needs to be performed to eject the concentrated ink. Thus, in step S1107, a concentration resolution flag is set to ON.

In this manner, after setting the circulation during the printing operation and the subsequent recovery operation flag, the printing operation is performed. After the printing operation ends, the nozzle is covered with the cap again to prevent the ink in the nozzle from drying out, and the present operation pauses.

Though the concentration of the ink in the nozzle and in the circulation path during the printing operation advances, since the color to be used is different depending on the next print image data and printing conditions, in the present embodiment, the concentrated ink recovery processing is executed when the printing operation is started. In a case where only the same ink is used, there is a possibility that the recovery processing of ink not used in the image formation can be skipped. This allows the effect of reducing the recovery processing time between printing operations to be obtained.

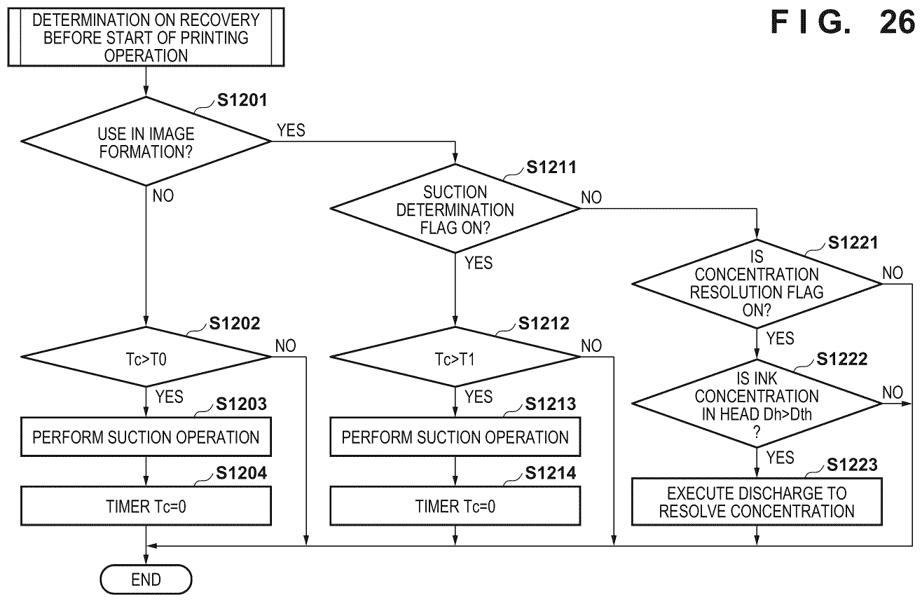

Next, FIG. 26 is a flowchart illustrating a determination on the recovery processing before the start of the printing operation and the recovery operation according to the present embodiment.

Firstly, in step S1201, whether or not a color is to be used in image formation is determined. The determination method is as described above. Here, for ink determined to not be used, since the ink is not used in image formation, even if the ink in circulation path became concentrated and even if the concentrated ink could not be circulated, it would not affect the image. However, it is necessary to prevent a state in which the aggregation of solids due to the advancement of the concentration of ink in the nozzle cannot be removed via suction. Thus, in step S1202, in a case where the count time of the timer Tc is greater than a threshold T0 for the amount of time required for recovery via suction, the suction operation is performed, and the concentrated ink in the nozzle is removed. Note that since the increase in viscosity when concentrated is different depending on the ink, T0 may be set to a different threshold depending on the ink. After the suction operation is performed, since the concentrated ink in the nozzle has been removed, the timer Tc is reset.

In a case where the color is determined to be a color to be used in the image formation in step S1201, next in step S1211, the suction determination flag is checked. In a case where the suction determination flag is ON from the previous printing operation, there is a possibility that the ink in the nozzle has not been circulated and is concentrated. Thus, in a case where it can be predicted, from the amount of time elapsed during which the nozzle has been exposed to the atmosphere, that the concentration level is sufficient to affect the image formation, the concentrated ink is removed via suction. Specifically, in step S1212, whether or not the timer Tc is longer than a threshold T1 is compared, and if the timer Tc is greater than the threshold, the suction operation is performed.

The threshold T1 is a threshold for effects on the image, that is, for ink concentration and concentration levels that affect discharge performance. Thus, the threshold T1 is set to a shorter time than the threshold T0 for determining whether the aggregation of solids has occurred. Also, since how much concentration affects the image is different depending on the ink, T1 may be set to a different threshold depending on the ink. After the suction operation is performed, in step S1214, the timer Tc is reset.

In step S1212, in a case where it is determined that the threshold has not be exceeded, it means that the ink concentration in the nozzle has not advanced and that the image formation will not be affected. Thus, the suction operation is not performed. Note that the suction determination flag ON condition means that the ink in the nozzle was not circulated in the previous printing operation. Thus, concentration of the ink in the entire circulation path has not advanced, and there is no need to resolve the concentration of ink in the circulation path. Thus, the concentration resolving operation is not performed.

In step S1211, in a case where the suction determination flag is OFF, next, in step S1221, the concentration resolution flag is checked. In a case where the concentration resolution flag is ON from the previous printing operation, the ink in the nozzle has been circulate. Thus, there is a possibility that the concentration of the entire circulation path has advanced. Thus, in step S1222, whether the ink concentration level is greater than a threshold Dth for a concentration level sufficient to affect image formation is determined. Specifically, the threshold Dth is compared with a concentration level Dh predicted from the concentration due to moisture evaporation from the nozzle and the concentration resolution depending on mixing in new ink upon ink consumption. In the present embodiment, for example, Dth=10% is set. When concentration level Dh>threshold Dth, in step S1223, a discharge operation is performed to eject the concentrated ink. In a case where concentration level Dh≤threshold Dth, since there is no need to resolve the concentration, the concentration resolution operation is not performed, and the recovery processing before printing operation ends.

As described above, in the present embodiment, whether or not to circulate ink not used in image formation during a printing operation is determined, and the ink is appropriately ejected on the basis of the concentration state in the nozzle and in the circulation path. In this manner, even when unused ink is used again in image formation, a state in which concentration variation and faulty discharge do not occur to cause deterioration in image quality can be maintained.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-097241, filed Jun. 13, 2023, which is hereby incorporated by reference herein in its entirety.

What is claimed is:

1. A printing apparatus, comprising:
an ink discharge head including a plurality of discharge ports that respectively discharge a plurality of types of ink, and a plurality of circulation paths for circulating ink between the plurality of discharge ports and a plurality of liquid chambers that respectively house the plurality of types of ink;
a circulation mechanism that circulates ink in the plurality of circulation paths; and
at least one processor or circuit configured to function as:
a control unit that performs control to determine, based on print data, which path among the plurality of circulation paths that circulation mechanism is to circulate ink in.

2. The printing apparatus according to claim 1, wherein the at least one processor or circuit is configured to further function as a selection unit that selects an ink to use in printing on a basis of the print data, and
wherein the control unit controls which circulation path of the plurality of circulation paths to circulate ink through according to an ink selected by the selection unit.

3. The printing apparatus according to claim 2, wherein the control unit controls the circulation mechanism to circulate ink in a circulation path associated with an ink selected by the selection unit.

4. The printing apparatus according to claim 3, wherein
the ink discharge head includes a plurality of chips where the plurality of discharge ports are divided in arranged in rows, and
the control unit controls the circulation mechanism to circulate ink in circulation paths associated with an ink with a discharge port disposed on an identical chip as a discharge port of an ink to be used in the printing.

5. The printing apparatus according to claim 4, wherein the ink discharge head includes a first chip including a discharge port that discharges a primer and a second chip including a discharge port that discharges black ink.

6. The printing apparatus according to claim 4, wherein the ink discharge head includes a second chip including a discharge port that discharges black ink and a fourth chip including a discharge port that discharges spot color ink.

7. The printing apparatus according to claim 6, wherein the spot color ink is one of green, orange, red, blue, and violet.

8. The printing apparatus according to claim 4, wherein the ink discharge head includes a first chip including a discharge port that discharges a primer, a second chip including a discharge port that discharges black ink, a third chip including a discharge port that discharges yellow ink, and a fourth chip including a discharge port that discharges spot color ink.

9. The printing apparatus according to claim 8, wherein
the second chip includes a discharge port that discharges light cyan ink and a discharge port that discharges cyan ink, and
the third chip includes a discharge port that discharges light magenta ink and a discharge port that discharges magenta ink.

10. The printing apparatus according to claim 8, wherein
the second chip includes a discharge port that discharges cyan ink and a discharge port that discharges magenta ink, and
the third chip includes a discharge port that discharges light magenta ink and a discharge port that discharges light cyan ink.

11. The printing apparatus according to claim 1, wherein the at least one processor or circuit is configured to further function as
a measuring unit that measures a circulation path elapsed time of how long ink circulation has not been performed during a printing operation of the printing apparatus.

12. The printing apparatus according to claim 11, further comprising:
a suction mechanism that suctions ink from the discharge port,
wherein the control unit controls the suction mechanism to suction, from the discharge port, ink associated with a circulation path in which the ink is not being circulated in a case where the elapsed time is greater than a first threshold.

13. The printing apparatus according to claim 12, wherein suction by the suction mechanism is performed before a next printing operation is started.

14. The printing apparatus according to claim 12, wherein the suction mechanism includes a cap that covers the discharge port and a pump that generates negative pressure inside the cap.

15. The printing apparatus according to claim 1, wherein the at least one processor or circuit is configured to further function as
a predicting unit that predicts a concentration level in the circulation path of ink to be circulation by the circulation mechanism.

16. The printing apparatus according to claim 15, wherein the control unit controls ink to be discharged from the discharge port in a case where the concentration level is greater than a second threshold.

17. The printing apparatus according to claim 16, wherein ink is discharged from the discharge port before a next printing operation is started.

18. The printing apparatus according to claim 1, wherein the control unit performs control to perform an ink ejecting operation before a next printing operation is started for an ink not used in a previous printing operation and for which an amount of time during which circulation has not been performed during a printing operation is greater than a third threshold.

19. A method for controlling a printing apparatus provided with an ink discharge head including a plurality of discharge ports that respectively discharge a plurality of types of ink, and a plurality of circulation paths for circulating ink between the plurality of discharge ports and a plurality of liquid chambers that respectively house the plurality of types of ink, the method comprising:
performing circulation to circulate ink in the plurality of circulation paths; and
performing control to determine, based on print data, which path among the plurality of circulation paths that circulation mechanism is to circulate ink in.

20. A non-transitory computer-readable storage medium storing a program for causing a computer to execute a method for controlling a printing apparatus provided with an ink discharge head including a plurality of discharge ports that respectively discharge a plurality of types of ink, and a plurality of circulation paths for circulating ink between the plurality of discharge ports and a plurality of liquid chambers that respectively house the plurality of types of ink, the method comprising:
performing circulation to circulate ink in the plurality of circulation paths; and
performing control to determine, based on print data, which path among the plurality of circulation paths that circulation mechanism is to circulate ink in.
